(19) United States
(12) Patent Application Publication
(10) Pub. No.: US 2017/0233595 A1
(43) Pub. Date: Aug. 17, 2017

(54) AQUEOUS POLYMER COMPOSITIONS FOR PRINTING, DIGITAL INK JET INKS AND PRINTING ONTO TEXTILES

(71) Applicant: Lubrizol Advanced Materials, Inc., Cleveland, OH (US)

(72) Inventors: Gabor Erdodi, Macedonia, OH (US); Devdatt S. Nagvekar, Broadview Heights, OH (US); Kurt Schroeder, North Royalton, OH (US); Naser Pourahmady, Solon, OH (US); Yun-Long Pan, Cincinnati, OH (US)

(21) Appl. No.: 15/503,240

(22) PCT Filed: Aug. 7, 2015
(86) PCT No.: PCT/US2015/044224

§ 371 Date: Feb. 10, 2017

Related U.S. Application Data
(60) Provisional application No. 62/035,697, filed on Aug. 11, 2014.

(51) Int. Cl. C09D 11/102; C09D 11/322; C09D 11/328; B41M 5/00; C08G 18/10; C08G 18/24; C08G 18/75; C09D 175/04; C09D 11/037; C08G 69/26

(52) U.S. Cl. CPC C09D 11/102; C09D 11/037; C09D 11/322; C09D 11/328; C08G 69/26; C08G 18/10; C08G 18/242; C08G 18/755; C09D 175/04; B41M 5/0023

(57) ABSTRACT

Polymer dispersions in aqueous media form binders for pretreatments, coatings and images on substrates. The polymer includes polyamide segments and may have a high percentage of tertiary amide linkages, which facilitates film formation at temperature convenient to textiles and nonwovens. The polyamides are linked with reactions with polyisocyanates (which forms urea linkages if the other reactant is an amine or a urethane linkage if the other reactant is a hydroxyl group).

### FIELD OF INVENTION

The invention relates to water borne polymer dispersions of the polyurea or polyurethane type comprising oligomers of polyamide used in printing processes. The polyamide makes useful flexible binders for various inks, pretreatments for ink printing, ink receptive coatings on otherwise difficult to print substrates, and overprint varnish (protective coatings) for use over images or text. The polyamides give desirable properties in terms of adhesion, resistance to solvents, resistance to UV light, etc.

### BACKGROUND OF THE INVENTION

GB 779247(A) published Jul. 17, 1957 teaches linear secondary polyamides for stoving compounds (often in combination with polyisocyanates). GB 1452073(A) published Oct. 6, 1976 teaches a blend of (A) a linear polyhydroxy polymer free of ethylene terephthalate units of molecular weight 400-4000 and being liquid at 80° C.; (B) a linear polyester of molecular weight 400 to 3000, melting point of 50-220° C. and 35-95 mol % of molecular chain is ethylene terephthalate; (C) a linear polyamide of molecular weight of 400-4000 and melting point of 100 to 200° C. in which at least 80% of the terminal groups are amino groups, and (D) an organic diisocyanate.

AU 669215(B2) published May 12, 1994 taught a 200-2000 molecular weight polyamide from various anhydrides or diacid halides with diamines, amino alcohol, amino thiol, and mixtures of these amine compounds. The polyamide is 6 to 25 wt. % of the total resins. The polyamide is reacted with excess diisocyanate to create an isocyanate terminated resin of 25,000 to 50,000 molecular weight. The resins are used in solvent based coatings.

EP 595281(A2) to BASF published May 4, 1994 and teaches a water dispersible ionic and nonionic polyamide modified polyurethane for use in automobile clearcoat and basecoat systems. The AU equivalent is AU 4903693.

EP595286(A1) to BASF published May 4, 1994 and interpreted based on AU-B-49162/93 teaches a solvent borne polyamide modified polyurethane resin for use in automotive clearcoat and basecoat.

“Novel Poly(urethane-amide)s from Polyurethane Prepolymer and Reactive Polyamides. Preparation and Properties”, Polymer Journal, Vol. 34, No. 6, pp 455-460 (2002) describes a soluble polyamide containing aliphatic hydroxyl group in the backbone that were reacted with a polyurethane prepolymer with isocyanate groups that were endcapped with phenol. The polyamide and prepolymer were mixed together and cast on glass substrates. The cast films were treated with heat to release the phenol, thereby unblocking the isocyanates, which then reacted with the hydroxyl groups of the polyamide.

U.S. Pat. No. 7,276,570 assigned to Acushnet Company discloses compositions for golf equipment, such as golf balls comprising thermoplastic, thermoset, castable, or millable elastomer compositions comprising at least one polymer having a plurality of anionic moieties attached thereto. The compositions can be used as part of golf ball construction.

WO2006/053777 A1 to Novartis Pharma GmbH discloses crosslinkable poly(oxyalkylene) containing polyamide prepolymers that can be used to provide water-soluble prepolymers that can be used as a component in contact lenses.

US 2006/0047083A1 published Mar. 2, 2006 discloses triblock thermoplastic polymers of the ABA type wherein the A blocks represent hard segments such as urethane, urea, urethane-urea, or amide type segments and the B blocks represent soft segments such as aliphatic polyethers, aliphatic polyesters, poly(dimethylsiloxane)s, polyalkanes and their copolymers.

US2008/081870A1 (equivalent to EP 190577(A2)) to Bayer describes a size composition comprising polyurethane-polyurea repeat units with carboxylic amide containing repeat units. The backbone contains 0.75 to 10 wt. % C(O)—NH groups. The composition is used as a sizing for glass fibers used in nylon compositions.

U.S. Pat. No. 5,610,224 (equivalent to EP059581) to BASF discloses an ionic and nonionic polyamide modified polyurethane polymers for use in coating compositions, method for forming, and coating compositions containing these polymers.

US 2008/0223519 A1 (equivalent WO2008/070762 A1) assigned to Arizona Chemical Company discloses polyamide polyols and polyurethanes, methods for making and using and products made therefrom. It discloses reaction products of a polymeric and non-polymeric diamine with dicarboxylic acid and hydroxy substituted carboxylic acid. It also discloses reactions of the polyamide with diisocyanates.

“Polyurethane-Amide Hybrid Dispersions”, Journal of Polymer Engineering, Vol. 29, Nos. 1-3, pp 63-78, 2009 describes aqueous polyurethanes with amide groups in the hard segments that were made by chain extending the prepolymer with various dicarboxylic acids. The particle size, mechanical and dynamic mechanical properties of cast films along with water swell and adhesion were studied.

WO2011/052707A1 titled Aqueous Polyamide Resin Dispersion, Method for Producing the Same, and Laminate discloses making a solvent dispersible polyamide for laminates.

US 2011/0124799 A1 to E. I. Du Pont de Nemours and Company describes inkjet inks for textiles containing crosslinked polyurethanes and further containing additional reactive components.

EP 449419 A1 describes reacting primary aminoalcohols with acid terminated polyamideethers to create hydroxyl terminated polymers.

### SUMMARY OF THE INVENTION

This invention relates to hydrolysis resistant polyamide oligomers and polyurea or polyurethane polymers derived therefrom that are useful to make a dispersion in aqueous media. The polymer dispersions in aqueous media are particularly useful in the printing area as binders in pretreatments, coatings, printed images, overcoat varnishes etc. A preferred, but not essential substrate are flexible substrates such as paper, woven and nonwoven fabrics, textiles and clothing, printed media, signs, etc. The polyamides can be chain extended by reactions with polyesters or polyethers. The terminal group on the polyamides can be converted to hydroxyl via reaction amine terminal groups with hydroxy carboxylic acids; or reactions of carboxyl terminal groups with amino alcohols. The polyamides can be linked via reactions between a polyisocyanate and amine or hydroxyl groups on the polyamide. A preferred polyamide typically has high percentage of tertiary amide linkages as these tertiary amide linkages are more easily processed near room temperature. The term polyurea/urethane is meant to cover polyamides where there are urea linkages and/or urethane linkages in the resulting polymer. The composition may contain small amounts of other polymers and materials (e.g. polyether or polyester segments) either as physical blends or where other oligomers or polymers are co-reacted into the polyamide containing polymer. The term polyamide oligomer will refer to an oligomer with two or more amide linkages, or sometimes the amount of amide linkages will be specified. A subset of polyamide oligomers will be telechelic polyamides. Telechelic polyamides will be polyamide oligomers with high percentages, or specified percentages, of two or more functional groups of a single chemical type; e.g. two terminal amine groups, meaning either primary, secondary, or mixtures; two terminal carboxyl groups; two terminal hydroxyl groups, again meaning primary, secondary, or mixtures; and two terminal isocyanate groups, meaning aliphatic, aromatic polyisocyanates, or mixtures. Reactive amine terminated telechelic polyamides will be telechelic polyamide oligomers where the terminal groups are both amine types, either primary or secondary or mixtures thereof, i.e. excluding tertiary amine groups.

In one embodiment, the polyamide can be in the form of polyurea/urethane polymer that is colloidally dispersed in water and is the reaction product of a polyisocyanate, defined as a molecule with two or more isocyanate groups, and an amine or hydroxyl terminated polyamide oligomer via a urea or urethane linkage. In preferred embodiments, the colloidal particles are characterized by their size and the polyamide is further characterized by its composition. In another embodiment, a liquid telechelic prepolymer is described a polyurea/urethane polymer or prepolymer comprised of a reaction product of a polyamide with at least two amide linkages and about two terminal Zerewitinoff groups with a polyisocyanate as described above, optionally with other molecules with Zerewitinoff groups. A Zerewitinoff group is defined as active hydrogen containing groups (such as amine or hydroxyl) that are reactive with isocyanates to form chemical bonds. A small amount of compatible solvent or ethylenically unsaturated monomers (such as free radically polymerizable monomers such as acrylic monomers) may be used to reduce the pre-polymer (oligomer) viscosity to facilitate dispersion in water (functioning as a plasticizer). A water-soluble diamine, hydrazine or hydrazide may be used in the aqueous media to promote chain-extension if an isocyanate terminated prepolymer is present.

In a preferred printing embodiment, the polyamide dispersion is used as an ink, a pretreatment on a substrate before printing to enhance image intensity or durability, as a printable (ink receptive) coating over a difficult to print substrate, as a printed image, or as a protective coating over a printed image or text. All of these printing applications require a relatively thin binder with good abrasion resistance, hydrolytic stability, UV resistance, etc. Such properties are available from the polyamide rich polymers. Preferred substrates include continuous or discontinuous film (sometimes flexible and sometimes not flexible), woven substrates, non-woven (e.g. spun bond, air laid, wetland, etc.) substrates, conventional woven textiles, etc. The inventive printing material generally comprises a binder from the polyurea or polyurethane comprising the polyamide, an optional pigment(s) if a colored binder is desired, optional filler, and optional dye, wherein at least 20 wt. % (more desirably at least 25, 30, 40, 50, 60, 70, 80 or 90 wt. %) of said binder in the pretreatment is characterized as amide repeat units being derived from amide condensation of monomers selected from dicarboxylic acid, lactam, aminocarboxylic acid, and diamine monomers. Generally, at least 5, 10 or 15 wt. % (more desirably at least 20, 25, or 30 wt. %) of the binder is also repeat units derived from polyisocyanates reacted with hydroxyl or amine groups to generate urea or urethane linkages at the two or more ends of each repeat unit derived from polyisocyanate. The repeat units derived from polyisocyanates will consist of the N—C—(═O) terminal groups and the residual portion of the polyisocyanate that was between the N—C—(═O) groups. It will not include the 0 of the hydroxyl group or the N of the amine group. In a preferred embodiment, at least 25 or 50 mole % of said amide linkages will be characterized as tertiary amide linkages (more desirably at least 60, 70, or 80 mole %) where the nitrogen bonded to a carbonyl group of the amide linkage also has two additional hydrocarbon groups chemically bonded to said nitrogen of said tertiary amide linkage. In the broadest scope of the invention, the polyamide can comprise amide repeat units from primary amine groups.

### DETAILED DESCRIPTION OF THE INVENTION

Definitions: We will use the parentheses to designate 1) that the something is optionally present such that monomer(s) means monomer or monomers or (meth)acrylate means methacrylate or acrylate, 2) to qualify or further define a previously mentioned term, or 3) to list narrower embodiments.

A first portion of this invention is the partial or complete substitution of polyamide segments for polyester, polyether, or polycarbonate segments in a polymer made from isocyanate derived hard segments and the already mentioned macromonomers. The replacement by polyamide segments for polyester, polyether, or polycarbonate segments can be partial or complete. Optimum environmental resistance would result from complete replacement of polyester and polyether segments, due to their potential for easier chain scission, but in some application some of the polyester and or polyether segments could be retained for their ability to soften the elastomeric portion or modify the compatibility of the resulting polymer with other polymer surfaces. When polymers from polyesters or polyethers are degraded by hydrolysis or UV activated chain scission the molecular weight of the polymer is decreased such that the polymer (or segment) exhibits decreased tensile strength, elongation to break, resistance to solvents, etc., relative to the same polymer before chain scission.

A second embodiment of this invention is the substitution of polyurea linkages for some or all of the urethane linkages. Urea linkages are derived from reacting an isocyanate group with a primary or secondary amine. Urethane linkages are derived from reacting an isocyanate group with an oxygen of a hydroxyl group. Urea linkages form hard segments with higher melting temperatures than urethane linkages. Thus, increasing the percentage of urea linkages increases the practical use temperature of a polymer, the temperature where the hard segment, if associated together, are sufficiently rigid such that the polymer does not permanently deform by plastic flow in response to stress.

A second benefit of the first portion of this invention (substituting low Tg polyamide segments for polyether or polyester segments) is that the polyamide segments tend to promote better wetting and adhesion than polyester or polyether based polyurethanes to a variety of polar substrates, such as glass, nylon, and metals. The hydrophobic/hydrophilic nature of the polyamide can be adjusted by using different ratios hydrocarbyl portion to amide linkages in the polyamide. Diacids, diamines, aminocarboxylic acids, and lactams with large carbon to nitrogen ratios tend to be hydrophobic. When the carbon to nitrogen ratio in the polyamide becomes smaller, the polyamide is more hydrophilic.

Thus polymers made from polyamide segments can have good solvent resistance. Solvents can deform and stress a polymer by swelling thereby causing premature failure of the polymer or parts from the polymer. Solvents can cause a coating to swell and delaminate from a substrate at the interface between the two. Adding polyamide to a polymer can increase adhesion to substrates that have similar or compatible surfaces to polyamides.

One objective of the current patent application is to use high percentages of amide linkages in a polymer segments incorporated via reaction with polyisocyanates into a copolymer with thermoplastic, optionally elastomeric, properties to provide resistance to chain scission from hydrolysis and UV activated chain scission. Thus, many embodiments will describe soft segments with high percentages of total linkages between repeat units in the soft segment being amide linkages. Some embodiments may allow for some linkages between repeat units to be other than amide linkages. In some embodiments the linkages between the polyamide oligomer and the isocyanate groups of the polyisocyanate will have significant portions of urea linkages. Urea linkages tend to have a higher melting temperature than urethane linkages and therefor provide higher use temperatures. Some embodiments may allow for urethane linkages between polyamide oligomers and the isocyanate groups of the polyisocyanate component, when preventing chain scission is not a top priority.

A preferred modification from conventional polyamides to get low Tg polyamide soft segments is the use of monomers with secondary amine terminal groups in forming the polyamide. The amide linkage formed from a secondary amine and a carboxylic acid type group is called a tertiary amide linkage. Primary amines react with carboxylic acid type groups to form secondary amides. The nitrogen atom of a secondary amide has an attached hydrogen atom that often hydrogen bonds with a carbonyl group of a nearby amide. The intra-molecular H-bonds induce crystallinity with high melting point and act as crosslinks reducing chain mobility. With tertiary amide groups the hydrogen on the nitrogen of the amide linkage is eliminated along with hydrogen bonding. A tertiary amide linkage that has one additional alkyl group attached to it as compared to a secondary amide group, which has hydrogen attached to it, has reduced polar interactions with nearby amide groups when the polymer exists in a bulk polymer sample. Reduced polar interactions mean that glassy or crystalline phases that include the amide linkage melt at lower temperatures than similar amide groups that are secondary amide groups. One way to source secondary amine reactant, a precursor to tertiary amide linkages, is to substitute the nitrogen atom(s) of the amine containing monomer with an alkyl group. Another way to source a secondary amine reactant is to use a heterocyclic molecule where the nitrogen of the amine is part of the ring structure. Piperazine is a common cyclic diamine where both nitrogens are of the secondary type and part of the heterocyclic ring.

Another modification to reduce the Tg of the polyamide soft segments is to use at least one additional chemically different monomer beyond the minimum number of monomers to form the polyamide. Thus, for a polyamide formed from a lactam polymerization such as from N-methyl-dodecyl lactam one would include an additional lactam, aminocarboxylic acid, diamine, or dicarboxylic acid in the monomers for the polymerization to change the spacing (among repeat units) between the amide linkages formed by the monomer so that the spacing between the amide linkages in the polyamide is irregular along the backbone and not the same physical dimension. For a polymerization of aminocarboxylic acid one would include additional lactam, aminocarboxylic acid, diamine, or dicarboxylic acid (with different physical length between the primary reactive groups of the monomer) in the monomer blend for the polymerization to change the spacing among repeat units between the amide linkages. Switching end groups on the monomers can also disrupt regularity in the spacing of the polar amide linkages and lower the effective Tg of the copolymer. Thus, co-polymerizing a C₆ amino carboxylic acid or lactam with a C₆ diacid and C₆ diamine can disrupt regularity of the amide linkages as the diacid and diamine units would switch the orientation of the amide linkage from head to tail orientation to tail to head orientation, slightly disrupting uniformity of spacing of the amide linkages along the polyamide backbone. Typically, when following this procedure one would try to add a disrupting monomer that increased or decreased the number of atoms between the amide forming end groups of the monomer(s) used as the primary monomer in the polyamide. One could also use a second disrupting monomer that had a cyclic structure (such as piperazine, a cyclic diamine monomer with where two methylene atoms form the top half of the ring and two methylene atoms form the bottom half of the ring) to disrupt the regularity of polyamide formed from a diacid reacted with a diamine monomer with two methylene atoms between the nitrogen atoms of the diamine.

In one embodiment, the binder is primarily polyamide repeating units. In another embodiment, the polyamide repeat units comprise at least 20, 30, 40, 50, 60, 70, 80, or 90 wt. % of the binder (or repeat units) of the pretreatment, coating or image. The remainder of the binder can be residues of polyisocyanates, polyether segments, polyester segments, polycarbonate segments, colloidal stabilizing species (such as acidic species for anionic stabilization, amine species for cationic stabilization, or polyalkylene oxide species for nonionic stabilization) or mixtures thereof. For the avoidance of doubt polyamide repeat units will typically comprise a hydrocarbon segment with one or two or more terminal groups with (heteroatoms that comprise oxygen or nitrogen) that form amide linkages. This can be considered as one or more terminal amide linkages per repeat unit if the carbonyl and the nitrogen are considered as being together at one end of the repeat unit or as two or more terminal groups selected from carbonyl or nitrogen at two or more ends (normally just two ends unless a branching repeat unit is developed) of each repeat unit. The hydrocarbon segment can optionally include up to 10 mole % heteroatoms of oxygen or nitrogen based on the moles of carbon and hydrogen atoms in the olefin. Repeat units of polyamides will be derived from condensation polymerization of carboxyl groups with amine groups.

In one embodiment, the ink, pretreatment, or coating is an ink (desirably for digital printing and desirably for digital ink jet printing). The ink can be one of several coatings applied to the substrate. Inks are generally applied as a layer thick enough to provide color brilliancy and wear resistance. Generally, thinner ink layers provide more desirable softer hand to printed fabrics. Inks can include pigments and/or dyes for coloration and fillers to increase volume and/or change the barrier properties of the coating. Inks can be in the form of an image when coatings of different colors are applied to decorate a flexible substrate. Sometimes an ink image or text of a single color that contrasts with the color of the substrate forms an image. This can be a discontinuous coating. At other times a multiple inks with different pigments and/or dyes will be selectively applied to form an image wherein the coating is continuous over a large portion of the substrate. An image will be a subset of continuous and discontinuous inks. Reactive dyes in inks are preferred over conventional dyes as they comprise reactive groups that can form a chemical bond to the substrate or an ink receptive layer applied to the substrate. Inks for ink jet printing are preferred and most ink jet printing is digital ink jet printing. Inks for ink jet printing can have the compositional limitations of Table 1.

Ink jet ink can be distinguished from other inks in that it is applied via a jetting technology of one or more colored inks to the desired substrate (also called non-impact printing) to create an image on the substrate. The other printing processes (impact types) include flexo, gravure printing, etc. The jetting is the transport of the ink through an orifice in the printing device and application to specific areas of the substrates (with the location or specific areas where the ink is applied being digitally controlled) where an image of a particular color(s) is desired. The orifices tend to be 10-50 microns in diameter and the print head is away from the printed surface by 0.1 to 1″. Orifices for jetting can be in columns, rows, and other configuration to allow the jetting of multiple columns, rows, and/or colors of ink in a single pass of the jetting device over a particular portion of the substrate. Digital technology helps coordinate the location of the jetting device relative to the x and y coordinates on the substrate such that control of the ink jetting process, color of ink, etc. creates a desired digitally controlled image. The smaller the orifice and the smaller the drop size the higher the resolution of the image (measured in dots per inches (dpi). The jetted ink portions tend to be 1-80 picoliters, depending on the resolution desired. Based on the printhead technology and its design inks used can be of lower viscosity (e.g., 2-5 cps) or higher viscosity (e.g., 10-15 cps) at the operating temperature. Lower viscosity inks tend to have smaller jetted drop sizes and higher viscosity inks tend to have slightly larger jetted drop sizes. The surface tension for both will desirably be from 25-40 dynes/cm range based on the substrate to print.

Jetting rates of 50,000-100,000 drops/sec are possible with an accuracy of 0.5 to 1 pixel. Drop velocities exiting from the jetting device can easily be 5-15 m/sec.

In another embodiment, the ink, pretreatment, or coating will be a pretreatment for a substrate. A preferred pretreatment substrate will be textiles as they have rougher surfaces and higher porosity than generally exists in films and papers (two other flexible substrates). A pretreatment on a film, paper, or textile helps with one of several properties. The pretreatment can enhance adhesion between subsequently applied images or coatings, acting as a tie material. The pretreatment can act as a coagulant for subsequently applied ink preventing the ink from bleeding to adjacent areas of the substrate or penetrating into the substrate. Pretreatments are common for textile printing to limit bleeding and penetration of the substrate (also called preventing strikethrough of the ink through the fabric to the backside) and to provide good adhesion between the substrate and any subsequently applied coatings. Pretreatments tend to be thinner than a protective coating and desirably do not stiffen the substrate appreciably. Pretreaments on textiles are intentionally often porous or semi-porous so that good air transfer and/or moisture vapor transmission through the textile is maintained. So pretreatments do not tend to be so thick and uniform that they become barriers to gases and liquids contacting the substrate. Pretreatments are often clear and do not comprise any pigment or filler. A very thin pretreatment limited to the fiber or yarn surfaces promotes a soft feel to the fabric (also called soft hand or soft touch/feel of the fabric). Effective pretreatments can provide enhanced image vibrancy by keeping pigmented inks near the image surface and preventing ink migration into the fabric. Desirably, pretreatments can comprise anionic or cationic groups or additives to promote coagulations of anionically or cationically stabilized inks upon contact. In one embodiment, the pretreatment desirably comprises from about 1 to about 12 weight percent of an anionic or cationic species incorporated into said binder and based on the weight of said binder. In one embodiment, the pretreatment desirably comprises at least about 2 weight percent of nonionic colloidal stabilizing species incorporated into said binder and based on the weight of said binder. In one embodiment, the pretreatment comprises from about 0.1 to about 10 or 20 grams of an acetidinium (AZE) containing polymer per 100 grams of the pretreatment or ink receptive coating. Effective pretreatments can help washfastness and abrasion resistance by binding any applied ink securely to the fibers or surface of the substrate.

The azetidinium functionalized polymer is well known to the wet strength enhancement of paper and to permanent press type functions to other clothing. Azetidinium functionalized polymers are known to be chemically reactive and form bonds to amine, carboxyl, hydroxyl, and thiol functionality on other materials such as substrates. While not wishing to be bound by theory, it is theorized that the azetidinium functionalized polymers bind both to the cotton fibers and to the binder in later applied inks, enhancing binder and color retention during laundry procedures on the printed image on the treated substrate. Preferred azetidinium functionalized polymers are formed by reacting epichlorohydrin with polymers containing secondary amine groups or with secondary amine groups on monomers that are subsequently polymerized or copolymerized with other ethylenically unsaturated monomers to form copolymers. Two preferred classes of azetidinium functionalized polymers include the reaction products of polyamides reacted with epichlorohydrin (known as PAE resins) and polyamines reacted with epichlorohydrin (known as PAmE resins).

An “azetidinium functionalized polymer” is a polymer comprised of monomeric subunits containing a substituted or non-substituted azetedine ring (i.e., a four membered nitrogen-containing heterocycle). In general, the azetidinium polymers useful herein are composed of monomer units having the structural formula (I):

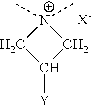

where X is usually chlorine and Y is usually OH along with optional other repeat units from other monomers. The dashed bond lines going to the polymer are going to alkylene groups, X⁻ is an anionic, organic or inorganic counter ion, and Y is selected from the group consisting of hydrogen, hydroxyl, halo, alkoxy, C₁-C₆ alkyl, amino, carboxy, acetoxy, cyano and sulfhydryl. Each of the methylene groups may independently also be substituted with a group selected from hydroxyl, halo, alkoxy, alkyl, amino, carboxy, acetoxy, cyano, C₁-C₆ alkyl, and sulfhydryl. Preferred polymers are where X⁻ is selected from the group consisting of halide, acetate, methane sulfonate, succinate, citrate, malonate, fumarate, oxalate and hydrogen sulfate, the methylene groups of the structure are independently non-substituted or substituted with a C₁-C₆ alkyl, and Y is hydrogen or hydroxyl.

The azetidinium polymer may be a homopolymer, or it may be a copolymer, wherein one or more non-azetidinium monomer units are incorporated into the polymer structure. Any number of co-monomers may be employed to form suitable azetidinium copolymers for use herein; however, a particularly preferred azetidinium copolymer is aminoamide azetidinium. Further, the azetidinium polymer may be essentially straight-chain or it may be branched or crosslinked. The amount of the azetidinium polymer is desirably from about 0.1 to about 10 or 20 wt. % as weight of active polymer per weight of the pretreatment, more desirably from about 0.2 to about 10 or 20 wt. %.

The percentage of reactive azetidinium groups in the polymer can be adjusted in a controlled manner to tailor the number of reactive groups in the polymer. Azetidinium groups are insensitive to pH change; however, such groups are highly sensitive to the presence of anionic and nucleophilic species. In some cases, it may be desirable to adjust the reaction conditions used to prepare the azetidinium polymer (e.g., by raising the pH) to generate anionic groups within the polymer, which then participate in intra-molecular crosslinking. At other times (such as when the polymer will be stored for weeks or months) it is desirable to keep the pH below 5, 4, or 3 to stabilize the polymer against crosslinking.

Desirably, these azetidinium functionalized polymers have at least 5, 10, or 15 azetidinium groups per polymer. There is an upper limit on the number of azetidinium groups because the polymer backbone can only have a limited number of secondary amine groups and the number of secondary amine groups limits the number of azetidinium groups on the polymer. The polymers of the functionalized polymers generally have a number molecular weight from about 5,000 to about 175,000 g/mole prior to functionalization with azetidinium groups. Within the industry they refer to low molecular weight polymers having molecular weights from 5,000 to 12,000 and higher molecular weight polymers having molecular weights from 125,000 to 175,000 g/mole. After functionalization with azetidinium groups the polymers can crosslink and further increase their molecular weight.

Such polymers are commercially available and include “AMRES™”, available from Georgia Pacific Resins, Inc., Atlanta, Ga., “KYMENE™”, from Hercules, Inc., Wilmington, Del., and “Polycup™”, from Hercules, Inc. and/or Ashland Chemical. These azetidinium polymers are generally referred to as poly(aminoamide)-epichlorohydrin (PAE) resins; such resins are typically prepared by alkylating a water-soluble polyamide containing secondary amino groups with epichlorohydrin. Other suitable azetidinium polymers will be known to those skilled in the art and/or are described in the pertinent texts, patent documents, and literature references. One example of making azetidinium functionalized polymers is U.S. Pat. No. 5,510,004 which details making azetidinium functionalized polymers for N,N-diallyl-3-hydroxyazetidinium and optional other co-monomers (PAmE, polyamine epichlorohydrin). Preferred co-monomers are acrylami de, diallylamine, diallylamine hydrohalides, methyldiallylamine, methyldiallylamine hydrohalides, dimethyldiallylammonium halides, maleic acid, sodium vinylsulfonate, sodium acrylate, sodium methacrylate, N,N-dimethylaminoethylmethacrylate, dimethylaminoethylacrylate, sodium salt of 2-acrylamido-2-methyl-1-propanesulfonic acid, N-vinyl-2-pyrrolidinone, N-vinylformamide, N-vinylacetamide, vinyl acetate, 2-vinylpyridine, 4-vinylpyridine, 4-styrenesulfonic acid, hydroxyethyl methacrylate, hydroxypropyl methacrylate, hydroxyethyl acrylate, hydroxypropyl acrylate, glycidyl acrylate and glycidyl methacrylate. The most preferred co-monomer is N-vinyl-2-pyrrolidinone. The preferred level of unsaturated co-monomer present in the copolymers in the reference is expressed as a mole fraction of N,N-diallyl-3-hydroxy azetidinium halide plus unsaturated co-monomer is from about 10 to about 85 mole percent, more preferably about 30 to about 65 mole percent and most preferably about 45 to about 55 mole percent. For the case of copolymers of N,N-diallyl-3-hydroxy azetidinium chloride and N-vinyl-2-pyrrolidinone, the preferred mole ratio is about 50% N,N-diallyl-3-hydroxy azetidinium chloride and about 50% N-vinyl-2-pyrrolidinone.

Another article on azetidinium functionalized polymer (PAE, polyamide epichlorohydrin) is Characterization of Polyamideamine-Epichlorohydrin (PAE) Resins, Roles of Azetidinium Groups and Molar Mass on PAE in Wet Strength Development of Paper Prepared with PAE; Takao Obakata et al., J. of Applied Polymer Science, Vol. 97, Issue 6, Jun. 28, 2005, pp. 2249-2255. In that article, they describe how to make a PAE resin by reacting methyl adipate and diethylene triamine at a 1:1 molar ratio at 130-140° C. for 5 hours to create a polyamide with a secondary amine group from the diethylene triamine. They cool the polymer to about 30° C. and add drop wise epichlorohydrin (at a 1.1:1 mole ratio of epichlorohydrin to the secondary amine group) for 30 minutes, dilute to 20 mass % with water, and then allow the reaction to continue for 4.5 hours. They then heated the mixture to 60° C. to convert the 3-chloro-2-hydroxypropyl group to azetidinium while keeping the pH below 3 to minimize crosslinking.

In one embodiment, the pretreatment, image, or coating is a protective overcoat or topcoat over a printed substrate or a pigmented finish. In the print business a clear coating over a printed image is often called an overprint varnish.

In one embodiment, the ink, substrate pretreatment, ink receptive coating, or overprint varnish is an ink receptive coating that can be applied to a substrate that may not have sufficient ink receptivity to form high vibrancy wear and wash resistance images by printing techniques. Often an ink receptive coating is applied when the substrate has lower ink receptivity than the proposed ink receptive coating. In one embodiment desirably the coating comprises from about 1 to about 12 weight percent of an anionic or cationic species incorporated into said binder and based on the weight of said binder. In one embodiment desirably the coating comprises at least about 2 weight percent of nonionic colloidal stabilizing species incorporated into said binder and based on the weight of said binder. In one embodiment, the coating or pretreatment comprises about 0.1 to about 10 weight percent of an acetidinium (AZE) group containing polymer based on the weight of said aqueous pretreatment before drying.

An image on a substrate is where a binder and a colored matter (such as a pigment or dye) are selectively applied to a substrate to create a visual image. The image can include gloss values if the gloss or matt nature of the coating can be independently controlled from the pigment or dye. Typically, any pigment known to the art can be used in the current coatings, images, and pretreatments. Generally, the pigments will be in particle sizes from 10, 20, 30, 40 or 50 nanometers up to 100, 200, 300, 400, or 500 nanometer in number average diameter by light scattering measurements in liquid media. When a dye is used instead of or in addition to the pigment the dye can react with the binder or the substrate or a portion of the substrate. Dyes tend to be more susceptible to UV light fading than pigments. Some dyes are soluble in water and some are soluble in organic media. Either type can be used in this disclosure. Dye fixatives can be used to prevent the dye from solubilizing from the intended location. Reactive dyes may be used, where reactive dyes are bound to the intended location by a chemical reaction between the dye and the material of the intended location.

An image can be applied by a variety of printing processes including screen printing, gravure printing, lithographic printing, digital printing and ink jet printing. Digital printing implies a digitized image is applied to a substrate. Ink jet printing implies that the ink was applied from drops of ink jetted through an orifice or nozzle under digital control of a device that decides what color of ink is applied to the substrate based upon a digital image. Ink jet devices are commercially available and generally the ink is optimized for the type of nozzle selected by the printer manufacturer. As the nozzle size gets smaller the viscosity of the ink typically gets lower to facilitate forming the smaller drop and accelerating it down the orifice towards the substrate. One skilled in ink jet printing can optimize the ink formulation with an aqueous or organic media, binder, pigment, dispersants, biocides, humectants, etc. to get optimal printing characteristics for the desired print head and nozzle design. Some printers use post printing techniques (e.g. radiation) to crosslink the binder and/or to evaporate the dispersion media to minimize any disruptions to the image from contact of the printed surface with any physical object (e.g. minimize smudges and smears of the ink).

A particular focus of this application is inks, pretreatments of substrates, ink receptive coatings, protective overprint varnishes and images on substrates. These substrates desirably have pretreatments, coatings, and images thereon that are also capable of deformation to accommodate expected and unexpected deformations of the substrates. The polyamide based binders are good in this application because they do not require high levels of crosslinking and thus can flex with the substrate. The polyamide based binders have some polar surface characteristics so that they can wet polar substrates to enhance bonding between the substrate and the pretreatment, coating or image. Flexible substrates are important to our society because they can be processed mechanically with equipment in continuous or semi-continuous form using rollers and compact machinery (as opposed to rigid substrates).

If the flexible substrate is a textile, it might be in the form of a roll-to-roll textile or in the form of a garment. It could be woven, nonwoven, or a film. It could be comprised of a single polymer or a blend of several polymers. Each fiber of the textile (if it is woven or nonwoven) could be a single polymer or a mixture of multiple polymers. Each fiber could be a single fiber or a complex mixture of several or many fibers (e.g. yarn) arranged together to give a particular characteristic. The fibers could be natural fibers such as cellulose, wool, silk, cotton, etc. or synthetic fibers such as rayon, nylon, polyester, polyethylene or polypropylene. In one embodiment, desirably at least 20, 40, 50, 60, 75, or 80 wt. % of the substrate (e.g. textile substrate) is one or more of the above listed polymers (e.g. cellulose, cotton, wool, silk, rayon, nylon, polyester, polyethylene, polypropylene, or mixtures thereof).

Desirably, the binder of the pretreatment, coating, or image has a good elongation to break, good modulus, and a surface tension between 20 and 60 dynes/centimeter in contact with air at 20° C. The tensile, modulus, and surface tension properties can be measured by making a film of the binder (without pigment, particulate filler, or plasticizer), annealing at a sufficient temperature such that a film is formed and cutting appropriate shaped specimen to run tensile, modulus, and surface tension tests. Desirably the binder when appropriate formed into films has an elongation to break of at least 100% of its original length, more desirably from about 200 to 500 or 800% of its original length. Desirably the binder in the form of a film has a tensile modulus of at least 1000 psi, and more desirably from about 2000 to about 6000 psi.

Another way to express the use of a copolymerization method to reduce the Tg and consequently the hardness of the polyamide is that the polyamide is characterized as being within a, b or c;

a) when said amide linkages are derived from polymerizing one or more monomers and more than 90 mole % of said monomers are derived from polymerizing monomers selected from lactam and aminocarboxylic acid monomer then said polyamide is defined as a copolymer of at least two different monomers, meaning said monomers are characterized as being at least two different monomers because they have hydrocarbyl portion of different spacing length between the amine and carboxylic acid groups, wherein each of said at least two different monomers is present at molar concentrations of at least 10%, more desirably at least 20 or 30%, of the total lactam and/or aminocarboxylic acid monomers in said polyamide, or
b) when said amide linkages are derived from polymerizing two or more monomers and more than 90 mole % of said monomers were derived from polymerizing dicarboxylic acid and diamine monomers then said polyamide is defined as a terpolymer of at least three different monomers (meaning said amide linkages are formed from at least three different monomers selected from the group of dicarboxylic acid and diamine monomers wherein said at least three different monomers are characterized as different from each other by a hydrocarbyl group of different spacing length between the carboxylic acid groups of the dicarboxylic acid, or different spacing length between the amine groups of the diamine, wherein each of said at least three different monomers is present at concentrations of at least 10 mole %, more desirably at least 20 or 30 mole %, of the total monomers in said polyamide), or
c) with the proviso that if said amide linkages are derived from polymerizing a combination of dicarboxylic acid, diamine and either lactam and/or aminocarboxylic acid monomers such that the total dicarboxylic acid monomer(s) and the diamine monomer(s) are present at 10 mole % or more, more desirably 20 or 30 mole % or more, and the total lactam and aminocarboxylic acid monomers are present in the monomer blend at 10 mole % or more, more desirably 20 or 30 mole % or more, then there are no restrictions requiring additional different monomers.

We use the term low Tg, glass transition temperature, even though we realize most of the polyamide segments are initially low molecular weight and it would not be easily possible to measure the Tg of the low molecular weight oligomers, e.g. the measured value would be dramatically affected by molecular weight. High Tg polymers, e.g. having Tg values above 70, 80, or 90° C. as measured by differential scanning calorimetry (DSC), would tend to form solids or gels even at low molecular weights. Thus the polyamide oligomers, telechelic polyamides, and even the prepolymers from telechelic polyamides or polyamide oligomers are often described in this specification by their viscosity at specific temperatures. Low Tg polyamide oligomers will be defined as those compositions that would have Tg, if above 20,000 g/mole molecular weight, of below 50, 25, or 0° C.

The term polyamide oligomer will refer to an oligomer with two or more amide linkages, or sometimes the amount of amide linkages will be specified. A subset of polyamide oligomers will be telechelic polyamides. Telechelic polyamides will be polyamide oligomers with high percentages, or specified percentages, of two functional groups of a single chemical type, e.g. two terminal amine groups (meaning either primary, secondary, or mixtures), two terminal carboxyl groups, two terminal hydroxyl groups (again meaning primary, secondary, or mixtures), or two terminal isocyanate groups (meaning aliphatic, aromatic, or mixtures). Ranges for the percent difunctional that are preferred to meet the definition of telechelic are at least 70 or 80, more desirably at least 90 or 95 mole % of the oligomers being difunctional as opposed to higher or lower functionality. Reactive amine terminated telechelic polyamides will be telechelic polyamide oligomers where the terminal groups are both amine types, either primary or secondary and mixtures thereof, i.e. excluding tertiary amine groups.

Many of the oligomers, telechelics, and polymers of this specification are made by condensation reactions of reactive groups on desired monomer(s). The condensation reaction of reactive groups will be defined as creating chemical linkages between the monomers. The portion of the monomer that is incorporated into the oligomer or polymer will be defined as the repeat unit from the particular monomer. Some monomers, such as aminocarboxylic acid, or one end of diacid reacting with one end of a diamine, lose one molecule of water as the monomer goes from a monomer to a repeat unit of a polymer. Other monomers, such as lactams, isocyanates, amines reacted with isocyanates, hydroxyl groups reacted with isocyanates, etc. do not release a portion of the molecule to the environment but rather retain all of the monomer in the resulting polymer.

We will define polyamide oligomer as a species below 20,000 g/mole molecular weight, e.g. often below 10,000; 5,000; 2,500; or 2,000 g/mole, that has two or more amide linkages per oligomer. Later we will define preferred percentages of amide linkages or monomers that provide on average one amide linkage per repeat unit in various oligomeric species. A subset of polyamide oligomer will be telechelic oligomer. The telechelic polyamide has molecular weight preferences identical to the polyamide oligomer above. The term telechelic has been earlier defined. Multiple polyamide oligomers or telechelic polyamides can be linked with condensation reactions to form polymers, generally above 100,000 g/mole.

Generally, amide linkages are formed from the reaction of a carboxylic acid group with an amine group or the ring opening polymerization of a lactam, e.g. where an amide linkage in a ring structure is converted to an amide linkage in a polymer. In a preferred embodiment, a large portion of the amine groups of the monomers are secondary amine groups or the nitrogen of the lactam is a tertiary amide group. Secondary amine groups form tertiary amide groups when the amine group reacts with carboxylic acid to form an amide. For the purposes of this disclosure the carbonyl group of an amide, e.g. in a lactam, will be considered as derived from a carboxylic acid group because the amide linkage of a lactam is formed from the reaction of carboxylic group of an aminocarboxylic acid with the amine group of the same aminocarboxylic acid. The formation of amides from the reaction of carboxylic acid groups and amine groups can be catalyzed by boric acid, boric acid esters, boranes, phosphorous acid, phosphates, phosphate esters, amines, acids, bases, silicates, and silsesquioxanes. Additional catalysts, conditions, etc. are available in textbooks such as “Comprehensive Organic Transformations” by Larock.

The polyamide oligomers and telechelic polyamides of this disclosure can contain small amounts of ester linkages, ether linkages, urethane linkages, urea linkages, etc. if the additional monomers used to form these linkages are useful to the intended use of the polymers. This allows other monomers and oligomers to be included in the polyamide to provide specific properties, which might be necessary and not achievable with a 100% polyamide segment oligomer. Sometimes added polyether, polyester, or polycarbonate provides softer, e.g. lower Tg, segments. Sometimes it is desirable to convert the carboxylic end groups or primary or secondary amine end groups of a polyamide to other functional end groups capable of condensation polymerizations. Sometimes an initiator for oligomer chain polymerization of a lactam is used that doesn't generate an amide linkage. Sometimes a polyether might be used as a segment or portion of a polyamide to reduce the Tg, or provide a soft segment, of the resulting polyamide oligomer. Sometimes a polyamide segment, e.g. difunctional with carboxylic acid or amine terminal groups, can be functionalized with two polyether end segments, e.g. from Jeffamine′ D230, to further lower the Tg of, or provide a soft segment in, the polyamide oligomer and create a telechelic polyamide with amine or hydroxyl end groups. Sometimes a carboxylic acid terminated telechelic polyamide segment is functionalized by reacting with an aminoalcohol, such as N-methylaminoethanol or HN(R^{α})(R^{β}) where R^{α} is a C₁ to C₄ alkyl group and R^{β} comprises an alcohol group and a C₂ to C₁₂ alkylene group, alternatively R^{α} and R^{β} can be interconnected to form a C₃ to C₁₆ alkylene group including a cyclic structure and pendant hydroxyl group (such as in 2-hydroxymethyl piperidine), either of which can create a telechelic polyamide with terminal hydroxyl groups. The reaction of the secondary amine (as opposed to the hydroxyl group) with the carboxylic acid can be favored by using a 100% molar excess of the amino alcohol and conducting the reaction at 160° C.+/−10 or 20° C. The excess amino alcohol can be removed by distillation after reaction. In one embodiment, a polyamide with a high percentage of tertiary amide linkages, such as at least 80% of said amide linkages being characterized as tertiary amide linkages, is used to make a telechelic prepolymer, characterized as the reaction product of a hydroxyl terminated polyamide with a polyisocyanate and optionally other molecules, where said telechelic polyamide is comprised of one or more repeat units from a lactone of 2 or 4 to 10 carbon atoms and/or a hydroxyl carboxylic acid of 3 to 30 carbon atoms. In one embodiment, said lactone and/or hydroxyl carboxylic acid are added after polymerization of an amine terminated polyamide and are reacted with said amine terminated polyamide to convert it to a hydroxyl terminated polyamide by being the terminal repeat unit(s) on one or both ends of said telechelic polyamide.

As earlier indicated many amide forming monomers create on average one amide linkage per repeat unit. These include diacids and diamines when reacted with each other, aminocarboxylic acids, and lactams. When we discuss these monomers or repeat units from these monomers, we generally mean these monomers, their repeat units and their reactive equivalents (meaning monomers that generate the same repeat unit as the named monomer). These reactive equivalents might include anhydride of diacids, esters of diacids, etc. These monomers, when reacted with other monomers in the same group, also create amide linkages at both ends of the repeat units formed. Thus we will use both mole percentages of amide linkages and weight percentages of amide forming monomers. Amide forming monomers will be used to refer to monomers that form on average one amide linkage per repeat unit in normal amide forming condensation linking reactions.

In one embodiment, desirably at least 10 mole %, more desirable at least 25, 30, 45, 50, 55 mole % of the number of the heteroatom containing linkages connecting hydrocarbon type linkages in the polyamide oligomer or telechelic polyamide are characterized as being amide linkages. Heteroatom linkages are linkages such as amide, ester, urethane, urea, ether linkages, where a heteroatom connects two portions of an oligomer or polymer that are generally characterized as hydrocarbons (or having carbon to carbon bond, such as hydrocarbon linkages). As the amount of amide linkages in the polyamide increase the amount of repeat units from amide forming monomers in the polyamide increases.

In one embodiment, desirably at least 20 or 25 wt. %, more desirable at least 30, 40, 50, 60, 70, 80, or 90 wt. % of the binder is repeat units from amide forming monomers, also identified as repeat units from monomers that form amide linkages at both ends of the repeat unit. Such monomers include lactams, aminocarboxylic acids, dicarboxylic acid and diamines. In one embodiment, desirably at least 25 wt. %, more desirable at least 30, 40, or 50 wt. % of the polyamide oligomer or telechelic polyamide is tertiary amide forming monomers, also identified as repeat units from monomers that form tertiary amide linkages at the amine ends of the repeat unit. Such monomers include lactams with tertiary amide groups, aminocarboxylic acids with secondary amine groups, dicarboxylic acid and diamines where both amine terminal groups are secondary amines.

In one embodiment, desirably at least 50 or 75 mole percent of the number of the heteroatom containing linkages connecting hydrocarbon type linkages in the polyamide oligomer or telechelic polyamide are characterized as being tertiary amide linkages. In one embodiment, desirably at least 25, 50, 75 mole percent of the linkages in the polyamide oligomer or telechelic polyamine are tertiary amide linkages. As earlier explained tertiary amide linkages result from ring opening polymerization of lactams with tertiary amides or reactions of secondary amines with carboxylic acid groups.

### Calculation of Tertiary Amide Linkage %:

The % of tertiary amide linkages of the total number of amide linkages was calculated with the following equation:

$$Tertiary amide linkage \% = \frac{{\sum }_{i = 1}^{n} ( {w}_{tertN , i} \times {n}_{i} )}{{\sum }_{i = 1}^{n} ( {w}_{totalN , i} \times {n}_{i} ) )} \times 100$$

where n is the number of monomers,
the index i refers to a certain monomer,
w_{tertN} is the average number nitrogen atoms in a monomer that form or are part of tertiary amide linkages in the polymerizations, (note: end-group forming amines do not form amide groups during the polymerizations and their amounts are excluded from w_{tertN}),
w_{totalN} is the average number nitrogen atoms in a monomer that form or are part of tertiary amide linkages in the polymerizations (note: the end-group forming amines do not form amide groups during the polymerizations and their amounts are excluded from w_{totalN}), and nᵢ is the number of moles of the monomer with the index i.

### Calculation of Amide Linkage %:

The % of amide linkages of the total number of all heteroatom containing linkages (connecting hydrocarbon linkages) was calculated by the following equation:

$$Amide linkage \% = \frac{{\sum }_{i = 1}^{n} ( {w}_{totalN , i} \times {n}_{i} )}{{\sum }_{i = 1}^{n} ( {w}_{totalS , i} \times {n}_{i} )} \times 100$$

where w_{totalS} is the sum of the average number of heteroatom containing linkages (connecting hydrocarbon linkages) in a monomer and the number of heteroatom containing linkages (connecting hydrocarbon linkages) forming from that monomer polymerizations. “Hydrocarbon linkages” are just the hydrocarbon portion of each repeat unit formed from continuous carbon to carbon bonds (i.e. without heteroatoms such as nitrogen or oxygen) in a repeat unit. This hydrocarbon portion would be the ethylene or propylene portion of ethylene oxide or propylene oxide; the undecyl group of dodecyllactam, the ethylene group of ethylenediamine, and the (CH₂)₄ (or butylene) group of adipic acid.

Preferred amide or tertiary amide forming monomers include dicarboxylic acids, diamines, aminocarboxylic acids and lactams. Preferred dicarboxylic acids are where the alkylene portion of the dicarboxylic acid is a cyclic, linear, or branched (optionally including aromatic groups) alkylene of 2 to 36 carbon atoms, optionally including up to 1 heteroatom per 3 or 10 carbon atoms, more preferably from 4 to 36 carbon atoms (the diacid would include 2 more carbon atoms than the alkylene portion). These include dimer fatty acids, hydrogenated dimer acid, sebacic acid, etc. Generally, we prefer diacids with larger alkylene groups as this generally provides polyamide repeat units with lower Tg value.

Preferred diamines include those with up to 60 carbon atoms, optionally including 1 heteroatom (besides the two nitrogen atoms) for each 3 or 10 carbon atoms of the diamine and optionally including a variety of cyclic, aromatic or heterocyclic groups providing that one or both of the amine groups are secondary amines, a preferred formula is

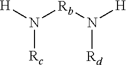

wherein R_{b} is a direct bond or a linear or branched (optionally being or including cyclic, heterocyclic, or aromatic portion(s)) alkylene group (optionally containing up to 1 or 3 heteroatoms per 10 carbon atoms of the diamine) of 2 to 36 carbon atoms and more preferably 2 or 4 to 12 carbon atoms and R_{c} and R_{d} are individually a linear or branched alkyl group of 1 to 8 carbon atoms, more preferably 1 or 2 to 4 carbon atoms or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being 1 or 2 to 4 carbon atoms. Such diamines include Ethacure™ 90 from Albermarle (supposedly a N,N′-bis(1,2,2-trimethylpropyl)-1,6-hexanediamine); Clearlink™ 1000 or Jefflink™ 754 both from Huntsman; N-methylaminoethanol; dihydroxy terminated, hydroxyl and amine terminated or diamine terminated poly(alkyleneoxide) where the alkylene has from 2 to 4 carbon atoms and having molecular weights from 100 to 2000; N,N′-diisopropyl-1,6-hexanediamine; N,N′-di(sec-butyl) phenylenediamine; piperazine; homopiperazine; and methyl-piperazine. Jefflink™754 has the structure

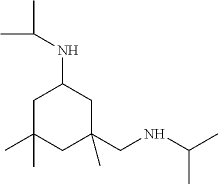 [SMILES: CC(C)NCC1(C)CC(NC(C)C)CC(C)(C)C1]

Clearlink™ 1000 has the structure

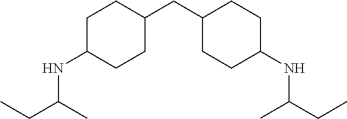 [SMILES: CCC(C)NC1CCC(CC2CCC(NC(C)CC)CC2)CC1]

Another diamine with an aromatic group is: N,N′-di(sec-butyl) phenylenediamine, see structure below:

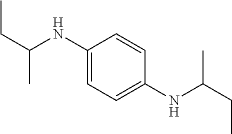 [SMILES: CCC(C)Nc1ccc(NC(C)CC)cc1]

Preferred diamines are diamines wherein both amine groups are secondary amines.

Preferred lactams include straight chain or branched alkylene segments therein of 4 to 12 carbon atoms such that the ring structure, without substituents on the nitrogen of the lactam, has 5 to 13 carbon atoms total (when one includes the carbonyl) and the substituent on the nitrogen of the lactam (if the lactam is a tertiary amide) is an alkyl of from 1 to 8 carbon atoms and more desirably an alkyl of 1 to 4 carbon atoms. Dodecyl lactam, alkyl substituted dodecyl lactam, caprolactam, alkyl substituted caprolactam, and other lactams with larger alkylene groups are preferred lactams as they provide repeat units with lower Tg values. Aminocarboxylic acids have the same number of carbon atoms as the lactams. Desirably the number of carbon atoms in the linear or branched alkylene group between the amine and carboxylic acid group of the aminocarboxylic acid is from 4 to 12 and the substituent on the nitrogen of the amine group (if it is a secondary amine group) is an alkyl group with from 1 to 8 carbon atoms, more preferably 1 or 2 to 4 carbon atoms. Aminocarboxylic acids with secondary amine groups are preferred.

In one embodiment, desirably at least 50 wt. %, more desirably at least 60, 70, 80 or 90 wt. % of said polyamide oligomer or telechelic polyamide comprise repeat units from diacids and diamines of the structure of the repeat unit being

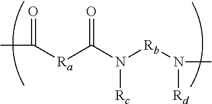

wherein Rₐ is the alkylene portion of the dicarboxylic acid and is a cyclic, linear, or branched (optionally including aromatic groups) alkylene of 2 to 36 carbon atoms, optionally including up to 1 heteroatom per 3 or 10 carbon atoms of the diacid, more preferably from 4 to 36 carbon atoms (the diacid would include 2 more carbon atoms than the alkylene portion) and

wherein R_{b} is a direct bond or a linear or branched (optionally being or including cyclic, heterocyclic, or aromatic portion(s)) alkylene group (optionally containing up to 1 or 3 heteroatoms per 10 carbon atoms) of 2 to 36 or 60 carbon atoms and more preferably 2 or 4 to 12 carbon atoms and R_{c} and R_{d} are individually a linear or branched alkyl group of 1 to 8 carbon atoms, more preferably 1 or 2 to 4 carbon atoms or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being an alkyl group of 1 or 2 to 4 carbon atoms.

In one embodiment, desirably at least 50 wt. %, more desirably at least 60, 70, 80 or 90 wt. % of said polyamide oligomer or telechelic polyamide comprise repeat unit units from lactams or amino carboxylic acids of the structure

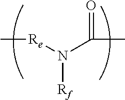

Repeat units can be in a variety of orientations depending on initiator type in the oligomer, derived from lactams or amino carboxylic acid wherein each Rₑ independently is linear or branched alkylene of 4 to 12 carbon atoms and each R_{f} independently is a linear or branched alkyl of 1 to 8 (more desirably 1 to 4) carbon atoms.

The above described polyamide oligomers and telechelic polyamide are useful to make prepolymers by reacting the polyamide oligomer or telechelic polyamide with polyisocyanates. Polyisocyanates will be used in this specification to refer to isocyanate containing species having two or more isocyanates groups per molecule. Desirably the polyamide oligomers and telechelic polyamide have terminal groups reactive with isocyanates to form urea linkages and/or urethane linkages. Groups chemically reactive with isocyanates to form chemical linkages are known as Zerewitnoff groups and include primary and secondary amines and primary and secondary alcohols. The nitrogen of the primary or secondary amine bonds to a carbonyl of the isocyanate and a hydrogen from the primary or secondary amine moves from the amine and bonds to the NH group of the isocyanate. The oxygen of a primary or secondary alcohol bonds to the carbonyl of the isocyanate and a hydrogen from the hydroxyl group of the alcohol moves and bonds to the NH group of the isocyanate.

During the reaction of the polyamide oligomers or telechelic polyamides with the polyisocyanates, one can have other species present with Zerewitinoff groups to co-react into the resulting polymer network. These can be low molecular weight species (say less than 500 g/mole diols or diamines) or higher molecular weight species (say 500 to 5000 g/mole oligomers that are added to form the high or low Tg phases in the resulting polymer). Generally, if one wants to make a polymer dispersion in water, one only reacts the components with a stoichiometry imbalance between the reactive groups to create moderate molecular weight species called a prepolymer with the functional group present in excess being the dominant terminus of most prepolymer units. This is usually accomplished by keeping the stoichiometry of the isocyanate groups to Zerewitinoff groups away from the 1:1 ratio (such that isocyanate or Zerewitinoff group terminated prepolymers of limited molecular weight are produced). The molecular weight of the prepolymer is kept fairly low (5000 g/mole to 100,000 g/mole) so that the prepolymer is a liquid at room temperature or slightly above room temperature (generally up to about 80° C.). This facilitates mixing of the prepolymer and dispersing of the prepolymer as small colloidally stable particles in water without the viscosity of the prepolymer interfering. Often an excess of isocyanate groups are used so that the prepolymer is isocyanate terminated.

The molecular weight of the prepolymer can be increased (or it is sometimes referred to as chain extending the prepolymer into a urethane polymer) after the dispersion of prepolymer is made. This can be done by adding to the dispersion low molecular weight species such as diols, triols, tetrols, or diamines, triamines or tetraamines that can react with isocyanate terminated prepolymers linking them into higher molecular weight species. A subset of useful polyamines include hydrazine and hydrazides. Hydrazides are the reaction product of hydrazine with di and polycarboxylic acids (e.g. adipic acid dihydrazide is useful and is made from adipic acid and two moles of hydrazine. Isocyanate groups on the prepolymer can also react with water in the continuous to generate CO₂ gas and terminal amine groups on some of the prepolymer. The amine groups on some of the prepolymer can then react with isocyanate groups on other prepolymers and chain extend both species. While the following paragraphs describe dispersing groups that can be incorporated into the prepolymer/polymer, it is also possible to utilize dispersants and surfactants of the anionic, cationic, nonionic, or zwitterionic type or mixtures thereof to facilitate the dispersion of the prepolymer/polymer in a continuous media.

Dispersing species such as anionic, cationic, nonionic, or zwitterionic species are desirably added to the prepolymer (or polymer) if it is desired to disperse the prepolymer (or polymer) in a continuous aqueous phase. These dispersing species help to provide colloidal stabilization to the dispersed phase. If surface active dispersing groups are to be incorporated into the polymer, it is desirable to include them in the reaction of the polyamide oligomer or telechelic polyamide with the polyisocyanate (e.g. during the prepolymer preparation). Dispersing groups that also have Zerewitinoff active groups, which react with isocyanate groups to form urea or urethane linkages, (e.g. dimethylolbutanoic acid, dimethylolpropanoic acids, and N-methyldiethanolamine) are particularly preferred for this purpose.

Polyureas and polyurethanes made from polyamide oligomers or telechelic polyamides are generally hydrophobic and not inherently water-dispersible. Therefore, at least one water-dispersability enhancing compound, i.e. a monomer with a dispersing functionality, which has at least one, hydrophilic, ionic or potentially ionic group is optionally included in the reactants for the polyurea or polyurethane polymers and prepolymers of this invention to assist dispersion of the polymer/prepolymer in water. Typically, this is done by incorporating a compound bearing at least one hydrophilic group or a group that can be made hydrophilic, e.g., by chemical modifications such as neutralization, into the polymer/prepolymer chain. These compounds may be of a nonionic, anionic, cationic or zwitterionic nature or the combination thereof. For example, anionic groups such as carboxylic acid groups can be incorporated into the prepolymer and subsequently ionized by a salt-forming compound, such as a tertiary amine defined more fully hereinafter. Anionically dispersible prepolymers/polymers based on carboxylic acid groups generally have an acid number from about 1 to about 60 mgKOH/gram, typically 1 to about 40, or even 10 to 35 or 12 to 30 or 14 to 25 mg KOH/gram. In one embodiment, it is desirable to have about 0, 1 or 2 to about 10 or 12% by weight of a diol, polyol or polyols or combinations thereof bearing active hydrogen groups as and containing a ionizable or potentially ionizable water dispersing group based on the weight of the binder. Other water-dispersibility enhancing compounds can also be reacted into the prepolymer backbone through urethane linkages or urea linkages, including lateral or terminal hydrophilic ethylene oxide or ureido units.

Water dispersability enhancing compounds of particular interest are those which can incorporate weak carboxyl groups into the prepolymer. Normally, they are derived from hydroxy-carboxylic acids having the general formula (HO)ₓQ(COOH)_{y}, wherein Q is a straight or branched hydrocarbon radical containing 1 to 12 carbon atoms, and x and y are 1 to 3. Examples of such hydroxy-carboxylic acids include dimethylol propanoic acid, dimethylol butanoic acid, citric acid, tartaric acid, glycolic acid, lactic acid, malic acid, dihydroxymalic acid, dihydroxytartaric acid, and the like, and mixtures thereof. Dihydroxy-carboxylic acids are more preferred with dimethylol propanoic acid and dimethylol butanoic acid being most preferred.

Another group of water-dispersability enhancing compounds of particular interest are side chain hydrophilic monomers. Some examples include alkylene oxide polymers and copolymers in which the alkylene oxide groups have from 2-10 carbon atoms as shown, for example, in U.S. Pat. No. 6,897,281, the disclosure of which is incorporated herein by reference.

Water dispersability enhancing compounds can impart cationic nature onto polyurethane. Cationic polyurethanes contain cationic centers built into or attached to the backbone. Such cationic centers include ammonium, phosphonium and sulfonium groups. These groups can be polymerized into the backbone in the ionic form or, optionally, they can be generated by post-neutralization or post-quaternization of corresponding nitrogen, phosphorous, or sulfur moieties. In one embodiment, it is desirable to have about 0, 1 or 2 to about 10 or 12% by weight of a diol, polyol, aminoalcohol, diamine or combinations thereof bearing active hydrogen groups as and containing a ionizable or potentially ionizable cationic water dispersing group based on the weight of the binder. The combination of all of the above groups can be used as well as their combination with nonionic stabilization. Examples of amines include N-methyldiethanol amine and aminoalcohols available from Huntsman under Jeffcat® trade name such as DPA, ZF-10, Z-110, ZR-50 and alike. They can make salts with virtually any acid. Examples of acid include hydrochloric, sulfuric, acetic, phosphoric, nitric, perchloric, citric, tartaric, chloroacetic, acrylic, methacrylic, itaconic, maleic acids, 2-carboxyethyl acrylate and other. Quaternizing agents include methyl chloride, ethyl chloride, alkyl halides, benzyl chloride, methyl bromide, ethyl bromide, benzyl bromide, dimethyl sulfate, diethyl sulfate, chloroacetic, acids and alike. Examples of quaternized diols include dimethyl diethanolammonium chloride and N,N-dimethyl-bis(hydroxyethyl) quaternary ammonium methane sulfonate. Cationic nature can be imparted by other post-polymerization reactions such as, for example, reaction of epoxy quaternary ammonium compounds with carboxylic group of dimethylol propanoic acid.

Other suitable water-dispersability enhancing compounds include thioglycolic acid, 2,6-dihydroxybenzoic acid, sulfoisophthalic acid, polyethylene glycol, and the like, and mixtures thereof.

Although the use of water-dispersability enhancing compounds is preferred, dispersions of the present inventions can be prepared without them by using high-shear dispersing methods and stabilizing by surfactants.

Suitable polyisocyanates have an average of about two or more isocyanate groups, preferably an average of about two to about four isocyanate groups per molecule and include aliphatic, cycloaliphatic, araliphatic, aromatic, and heterocyclic polyisocyanates, as well as products of their oligomerization, used alone or in mixtures of two or more. Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1, 6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis-(isocyanatomethyl) cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate, toluene diisocyanate, their isomers, naphthalene diisocyanate, and the like. Preferred aromatic polyisocyanates include 4,4′-diphenylmethylene diisocyanate and toluene diisocyanate.

Examples of suitable heterocyclic isocyanates include 5,5′-methylenebisfurfuryl isocyanate and 5,5′-isopropylidenebisfurfuryl isocyanate.

Polyamide-based polyurea/urethane compositions were made in waterborne dispersion form with high molecular weight, e.g. Mw>80 000 g/mol, high solid content, e.g. 25-40 wt. %, various particle size, e.g. 40-200 nm. The dispersions were made with NMP, N-methylpyrrolidone, solvent, e.g. 0-11% in formulation, or with solvent process (NMP-free method) using IPA.

Good quality, clear, colorless (or very faint yellow color) polyurea and or polyurethane with polyamide segment in the form of films formed from the dispersion. The films had high tensile strength, e.g. 35,000-55,000 psi, moderate elongation, e.g. 250-300%, films.

Conventional Blends with Other Polymers

The dispersions of this invention can be combined with compatible polymers and polymer dispersions by methods well known to those skilled in the art. Such polymers, polymer solutions, and dispersions include those described in A. S. Teot. “Resins, Water-Soluble” in: Kirk-Othmer Encyclopedia of Chemical Technology. John Wiley & Sons. 3rd Edn., Vol. 20, H. F. Mark et al. Eds., pp. 207-230 (1982).

Composite Polymer Compositions (e.g. Polyurea/Urethane with Free Radically Polymerizable Monomers) Providing Better Interpenetration of Phases

In this embodiment, one can use ethylenically unsaturated monomer(s) as a solvent to reduce the viscosity of the prepolymer during preparation and dispersion of the prepolymer or polyurea/urethane and subsequently polymerize the unsaturated monomer(s) to form a polymer. Ethylenically unsaturated monomers and other free radically polymerizable monomers can be polymerized by conventional free radical sources to form a polymer within the polyurea/urethane particle to form a composite polymer with the polyurea/urethane polyamide of the dispersion. Vinyl polymers is a generic term for polymers derived from substantial portions of unsaturated monomers or polymers derived from those monomers. Acrylic, often considered a subset of vinyl, will refer to acrylic acid, acrylates, being esters of acrylic acid, and alkacrylates, such as methacrylates and ethacrylates, and polymers therefrom. Additional free-radically polymerizable material, e.g. other unsaturated monomers, may be added to the vinyl or acrylic monomers to copolymerize. These other monomers can be monomers such as maleic anhydride, maleic acid, and other monomers where the carbon-carbon double bond is nearly as reactive (and copolymerizable with) as a ethylenically unsaturated monomers. Dienes are considered ethylenically unsaturated and copolymerize with both the broad category of vinyl monomers and narrow category of acrylic monomers.

The polymerization within the polyurethane particles can be done by forming the aqueous dispersions of polyurea/urethane composite and then polymerizing additional monomers by emulsion or suspension polymerization in the presence of these dispersions. Another way of making composite polymers is to include ethylenically unsaturated monomers in the polyurea/urethane prepolymer, e.g. either with the reactants to form the prepolymer and/or any time before the urethane prepolymer is dispersed, and cause these monomer to polymerize before, during and/or after the prepolymer is dispersed in aqueous medium. In one embodiment, the weight percent of polymer(s) from vinyl monomers based on 100 parts of combined urea/urethane and vinyl (or acrylic in narrower embodiments) will be at least 1, 5, or 10 weight percent with the complementary amount of urea/urethane prepolymer or polymer to make 100 parts by weight total. In another embodiment, where small amounts of urea/urethane prepolymer or polymer are desired, the urea/urethane prepolymer or polymer is at least 0.1, 0.5, 1, 5 or 10 weight percent of the combined weight and the vinyl (or acrylic in narrower embodiments) polymer is the complementary amount.

In one approach, the ethylenically unsaturated monomers act as a diluent (or plasticizer) during prepolymer formation. When the vinyl monomers are used as a diluent for the polyurea/urethane component then the vinyl monomers will be from about 5 or 10 weight percent to about 50 weight percent of the combined weight of the polyurea/urethane and vinyl component (monomer or polymer, depending on whether polymerization has occurred or not). Composites of polyurea/urethanes of this invention with and acrylics can be made by any of these approaches. In one embodiment, the telechelic polyamides with alcohol terminal groups are useful to form polyurethanes and polyurethane dispersions in water with lower processing temperatures and lower minimum film formation temperatures than similar polymer dispersions where secondary amino groups are in the position of the terminal hydroxyl groups. These can result in better films or the ability to incorporate more polyamide in a polymer dispersion or higher melting polyamide in a polymer dispersion. It is desirable that these alcohol terminal groups are derived from reacting aminoalcohols having secondary amino groups with carboxylic acid terminated polyamides as described in paragraph 0053. This is because the secondary amino groups form urea linkages with di or polyisocyanates and hydroxyl groups for urethane linkages with di or polyisocyanates. Urea linkages result in polymers that require higher processing temperatures and have higher minimum film formation temperatures than urethane linkages in similar polymers.

Broadened Definition of Composite and/or Hybrid Polymer in Dispersion in Water

Composite and/or hybrid polymers dispersed in aqueous media (water) with significant amounts of polyamide segments therein have not been extensively disclosed in the literature and said composite and/or hybrid polymers can have desirable lower film formation temperature, better adhesion to some polar substrates, better elongation to break, better tensile strength, better retention of properties after aging, etc. than current urethane and/or polyamide compositions on the market. Composites and/or hybrid compositions can allow one to adjust the weight percentage of polyamide repeat units relative to other repeat units (e.g. optionally polyether, polycarbonate, polyester segments, polysiloxane, etc.) in the condensation polymer to optimize the modulus at a particular temperature or to move the minimum film formation temperature up or down by adding softer or harder polymer segments relative to the polyamide. Condensation polymer is a generic term for polymers made by coupling reactive groups like amine, carboxylic acid, isocyanates, hydroxyl, etc. to form chemical bonds (as opposed to free radical chain polymerizations). Composite and/or hybrid compositions also allow adjustment of the weight percentage of polyamide by increasing the weight percentage of vinyl polymer without increasing the amount of polyamide. Thus this technology provides several ways to independently control the amount of polyamide in the composite particles, which can have effects on the polarity or hydrogen bonding of the composite particles, the surface tension of the composite particles, and/or the modulus, tensile strength, etc. of the composite polymer at a particular key temperature.

By the term composite and/or hybrid we intend to include a variety of mixtures of other polymers with a polyamide rich polymer type. A focus of this disclosure is ways to add polyamide segments to a polymer dispersion in water such that desirably features of polyamide can be achieved without some detrimental features such as high polymer processing temperatures. The polymers that contain polyamide segments may have other comonomers or comonomer segments linked directly or indirectly to the polyamide segments. These comonomers can include things like polyethers, polyesters, polycarbonates, polysiloxanes, etc. The composite and/or hybrid polymers of the composite and/or hybrid dispersions have approximately the same particle size ranges as disclosed for the polyamide dispersions in water.

The composite and/or hybrid polymer dispersions may have within the polymer comprising polyamide segments anionic, nonionic, or zwitterionic colloidal stabilizing groups as earlier disclosed for the polyamide dispersions in water.

In one embodiment, we disclose a composite and/or hybrid polymer dispersion in the form of dispersed hybrid polymer particles in aqueous medium, said composite and/or hybrid polymer dispersion comprising at least 5 wt. % (in some embodiments more desirably at least 10, 15, 20, 30 or 40 wt. %) of polyamide segments derived from amide forming condensation polymerization of monomers selected from diamines, amino carboxylic acids, lactams, and dicarboxylic acids, said wt. % based on the weight of said hybrid polymer dispersion in aqueous medium, said polyamide segments characterized as the entire weight of repeat units from said monomers having terminal amide linkage(s) at one or both ends of repeat units from said monomers. In a more preferred embodiment, said amide linkages are characterized as being at least 50, 70, 90, or 95 mole % amides linkages of the type formed from the reaction of a secondary amine with a carboxylic acid (i.e. a tertiary amide linkage). We note that lactam monomers forming tertiary amide linkages start out as tertiary amide linkages, ring open, and then form polymers with tertiary amide linkages. We intend the above language regard amide linkage of the type formed from secondary amines reacted with carboxylic acid to include those derived from lactams with tertiary amide linkages.

In one embodiment, the composite particles also comprise at least 5 wt. % (in some embodiments more desirably at least 10, 15, 20, 30 or 40 wt. %) of a vinyl polymer interspersed with said polyamide segments within the same polymer particles as said polyamide segments, wherein said vinyl polymer is derived from the free radical polymerization of one or more vinyl monomers in the presence of said polyamide segments (vinyl monomers being defined in this context as having at least alpha-beta unsaturation and desirably having from 3 to about 30 carbon atoms, including but not limited to (alk)acrylates, vinyl esters, unsaturated amides, acrylonitrile, dienes, styrene, AMPs monomer, etc.), and water. The water can be present in amounts from about 10, 20, or 30 weight percent of the polymer dispersion to about 70, 80, or 90 wt. % of the polymer dispersion. Typically, lower water content saves on shipping costs for the same amount of polymer but viscosity of the dispersions tend to rise when the water content is minimized.

In one embodiment, it is desirable that the polymer containing the polyamide segments be partially crosslinked to increase the physical properties of the polymer such as tensile strength and modulus. In one embodiment, the amount of ketone crosslinkable functional groups in the composite or hybrid polymer will be at least 0.05 milliequivalents per gram of said polymer dispersion, or up to about 1 milliequivalent, preferably from about 0.05 to about 0.5 milliequivalent, and more preferably from about 0.1 to about 0.3 milliequivalent per gram of said polymer dispersion. In that embodiment, the ketone groups can be on the polyamide containing polymer or the vinyl polymer. In another embodiment, said composite or hybrid polymer dispersion has at least 10, 20, 30, 40 or 50 wt. % of said polyamide segments chemically bonded into polymers comprising on average one or more ketone groups per said polymer. In another embodiment said polymer dispersion further comprises hydrazine and/or hydrazide groups (sometimes in the form of low molecular weight species and sometimes in the form of polymers with hydrazide groups) in an amount from 10 mole % to about 200 mole % of hydrazine and/or hydrazide groups based on the moles of said ketone groups. This provides for a ketone chemical reaction with hydrazine forming a chemical bond that can function as chemical crosslinking. Typically, when adding hydrazine for crosslinking one doesn't use an excess of hydrazine because of potential undesirable reactions of hydrazine on humans. In one embodiment, the amount of hydrazine or hydrazide groups is desirably from about 20 to 100 mole % of the amount of ketone functional groups.

In one embodiment, said hydrazine and/or hydrazide groups are part of a reactive hydrazine or hydrazide compound of less than 400, 300 or 220 g/mole molecular weight (such as adipic acid dihydrazide). In another embodiment, said hydrazide groups are present and said hydrazide groups are part of a hydrazide reactive oligomeric or polymeric chemical compound of 300 or 400 g/mole to 500,000 g/mole molecular weight.

In another embodiment, said vinyl polymer comprises on average one or more (more desirably up to about 1 milliequivalent, preferably from about 0.05 to about 0.5 milliequivalent, and more preferably from about 0.1 to about 0.3 milliequivalent per gram of vinyl polymer on a dry vinyl polymer weight basis) ketone groups per vinyl polymer and said dispersion further comprises hydrazine and/or hydrazide groups in an amount from 10 mole % to about 200 mole % based on the moles of said ketone groups.

The ketone-hydrazine crosslinking described above is well known in the urethane and acrylic polymer dispersion art as effective crosslinkers for polymeric dispersions at around room temperature upon evaporation of volatile base and shift of the solution pH from slightly basic to neutral or pH acid. The author, Anthony D. Pajerski, has several patents on urethanes and related compounds in water crosslinked or increased in molecular weight by ketone-hydrazine crosslinking. This technology is also sometimes known as azomethine linkages.

Air-oxidizable, self-crosslinkable (unsaturation) crosslinkers can also be conveyed into the polymer of the composite or hybrid dispersion. The self-crosslinkable groups can be inserted into the polymer backbone via active hydrogen containing (isocyanate-reactive) unsaturated fatty acid ester polyol(s) (e.g., oil modified polyols). The resulting unsaturation in the polymer imparts air curable latent crosslinkability so that when a coating composition containing such a component is dried in the air (often in conjunction with a drier salt) the coating undergoes a self-crosslinking reaction. By isocyanate reactive is meant that the unsaturated fatty acid polyol contains at least two hydroxyl groups (containing active hydrogen atoms) that are available for reaction with the isocyanate groups on the polyisocyanate. The oil modified polyols employed in the invention are conventional in the art. They are generally produced by reacting a polyfunctional alcohol (polyol) with a drying oil (glyceride) or a free fatty acid. The fatty acid component(s) of the drying oils and free fatty acids are characterized by containing at least one olefinic carbon-carbon double bond and can have two, three or more olefinic double bonds. The amount of unsaturated fatty acid ester polyol (or drying oil) to utilize will depend on many factors such as the degree of flexibility desired in the final composition and the nature and the amount of the other reactants used in the prepolymer formation as well as the degree and rate of air curing that is desired for the polymer.

Unsaturated fatty acid ester polyols also can be obtained by reacting an unsaturated fatty acid with an epoxy group containing compound. In one aspect of the invention, the polyfunctional alcohols which can be used to prepare the oil modified polyols generally contain from 2 to about 12 carbon atoms. In another aspect of the invention, polyfunctional acids and acid anhydrides can be reacted with polyfunctional alcohols to obtain polyester polyols for use as a polyfunctional alcohol. Such acids and anhydrides useful in this aspect of the invention generally contain from 4 to about 36 carbon atoms. The unsaturated fatty acids which can be utilized in the preparation of the oil modified polyols of the invention include the ethylenically unsaturated and polyunsaturated fatty acids and their esters. The fatty acids can contain from 1 to about 3 olefinic double bonds or more and include conjugated and non-conjugated unsaturation. It is intended that the fatty acids encompass and include all natural and synthetic positional isomers with respect to the location of the unsaturated carbon-carbon double bonds. In another aspect of the invention, the fatty acids contain two to three unsaturated double bonds. The unsaturated fatty acids that can be employed in preparing the oil modified polyol include but are not limited to those formed by the hydrolysis of any of the so called drying or semidrying oils, such as linseed oil, poppyseed oil, tung oil, etc. Synthetically modified unsaturated fatty acids also can be employed in the preparation of the unsaturated fatty acid ester polyols of the invention. The properties of unsaturated fatty acids and their derivatives can be altered by rearrangement, i.e., isomerization, of the structure of the double bond, either with respect to the steric position or the position in the carbon chain of the molecule of the fatty acid.

The composite and/or hybrid polymer dispersion may further comprise from about 0.5 to about 10 wt. % of C₁ or C₃ to C₁₂ secondary alcohols based on the weight of said dispersion to function as simple hydrogen bonding donating components to the polyamide segments and soften or plasticize the composition (to enhance film formation at lower temperatures or lower viscosity during the dispersion process). The composite and/or hybrid polymer dispersion may also comprise alkylene oxide glycol ethers of less than 300 or 400 g/mole molecular weight in amounts of about 0.5 to about 10 wt. % of the polymer dispersion. The composite and/or hybrid polymer dispersion may also comprise anionic, nonionic, or zwitterionic surfactants to help colloidally stabilize the dispersion.

The composite and/or hybrid polymer dispersion may further comprising from about 1 to about 10 wt. % of a polysiloxane chemically bonded directly or indirectly to one or more of said polyamide segments. Polysiloxane polyols are characterized by the presence of the —Si(R₁)(R₂)—O— repeat units which can contain C₁-C₃-alkyl or aryl groups such as polydimethylsiloxanes, poly(dimethysiloxane-co-diphenylsiloxane)s, polydiphenylsiloxanes, poly(methylphenyl)siloxanes and the like, and combinations thereof. Examples include ethoxylated poly(dimethylsiloxane) (PDMS) Y-17256 from Momentive Performance Materials and side-chain PDMS diol MCR-C61 from Gelest.

A composite and/or hybrid polymer dispersion according to earlier disclosures may further comprise urea and/or urethane linkages bonded directly or indirectly to one or more of said polyamide segments. This uses the polyamide segment (wherein a majority of amide linkages tertiary amide linkages as previously discussed) and the segments of polyamide are sometimes or often linked with urethane or urea linkages derived from reacting polyisocyanates with hydroxyl and/or amine groups. Thus, the polyamide segments would be chain extended by urethane or urea linkages. In one embodiment, where amine (primary or secondary) reactive groups are reacted with isocyanate groups, there are on average at least 4 urea linkages per every 20 amide linkages in said polymer. In another embodiment, where urethane linkages are preferred and made from reaction of hydroxyl terminated segments with isocyanate groups, there are on average at least 4 urethane linkages per every 20 amide linkages in said polyamide segments.

### Processes

Aqueous dispersions of polyurea/urethane particles are made in accordance with this invention by forming the polyurea/urethane prepolymer in the substantial absence of water (as water reacts with isocyanate groups) and then dispersing this prepolymer in aqueous medium. This can be done in any of the methods known to the art. Typically, prepolymer formation will be done by bulk or solution polymerizing the ingredients of the prepolymer.

Once the polyurea/urethane prepolymer mixture is formed, optionally with dispersing moieties incorporated into said prepolymer/polymer, it is dispersed in an aqueous medium to form a dispersion or a solution. Dispersing the prepolymer in aqueous medium can be done by any conventional technique in the same way that polyurethane prepolymers made by bulk or solution polymerization are dispersed in water. Normally, this will be done by combining the prepolymer blend with water with mixing. Where solvent polymerization is employed, the solvent and other volatile components can optionally be distilled off from the final dispersion, if desired. Where the prepolymer includes enough water-dispersibility enhancing compound, e.g. anionic, cationic, and/or nonionic monomers, to form a stable dispersion without added emulsifiers (surfactants), the dispersion can be made without such compounds, i.e., substantially free of surfactants, if desired. The advantage of this approach is that the coatings or other products made from the polyurea/urethane without low molecular weight surfactants exhibit less water sensitivity, often better film formation and less foaming.

Other known ways of making aqueous polyurethane dispersions can also be used to make the dispersions of this invention. Their review can be found in several publications including by D. Dieterich in Progress in Organic Coatings, vol. 9, pp. 281-340 (1981). Examples of the processes include:

Shear Mixing—Dispersing the prepolymer by shear forces with emulsifiers (external emulsifiers, such as surfactants, or internal emulsifiers having anionic, nonionic, cationic and/or zwitterionic groups as part of or pendant to the polymer backbone, and/or as end groups on the polymer backbone).

Acetone process—A prepolymer is formed with or without the presence of acetone, methyl ethyl ketone MEK, and/or other polar solvents that are non-reactive with isocyanates and easily distilled. The prepolymer is further diluted in said solvents as necessary, and chain extended with an active hydrogen-containing compound. Water is added to the chain-extended polymer, and the solvents are distilled off. A variation on this process would be to chain extend the prepolymer after its dispersion into water.

Melt dispersion process—An isocyanate-terminated prepolymer is formed, and then reacted with an excess of ammonia or urea to form a low molecular weight oligomer having terminal urea or biuret groups. This oligomer is dispersed in water and chain extended by methylolation of the biuret groups with formaldehyde.

Ketazine and ketimine processes—Hydrazines or diamines are reacted with ketones to form ketazines or ketimines. These are added to a prepolymer, and remain inert to the isocyanate. As the prepolymer is dispersed in water, the hydrazine or diamine is liberated, and chain extension takes place as the dispersion is taking place.

Continuous process polymerization—An isocyanate-terminated prepolymer is formed. This prepolymer is pumped through high shear mixing head(s) and dispersed into water and then chain extended at said mixing head(s), or dispersed and chain extended simultaneously at said mixing head(s). This is accomplished by multiple streams consisting of prepolymer (or neutralized prepolymer), optional neutralizing agent, water, and optional chain extender and/or surfactant.

Reverse feed process—Water and optional neutralizing agent(s) and/or extender amine(s) are charged to the prepolymer under agitation. The prepolymer can be neutralized before water and/or diamine chain extender is added.

### Additives and Applications

Because the polyamide and the urea linkages have higher softening temperatures than polyethers, polyesters, and urethane linkages, it is desirable to include coalescing aids in the prepolymers and polymer dispersions of this disclosure to help promote coalescence at the desired temperature of the polymer particles with each other and with any solid additives in the compositions. Coalescing aids can also be known as solvents or plasticizers, depending on their function. One coalescing aid is the vinyl monomers earlier discussed with composite polymer blends. Preferred vinyl monomers include methyl methacrylate, butyl acrylate, ethylhexyl acrylate, ethyl acrylate and styrene. Coalescing solvents include diethylene glycol dimethyl ether, dipropylene glycol dimethyl ether, dimethylcarbonate, isopropyl alcohol, dibutylene glycol dimethyl ether, dimethyl carbonate, and Texanol (isobutyric ester of 2,2,4-trimethyl-1,3-pentanediol).

Neutralization agents can optionally be employed in the dispersions of the invention and the coating compositions prepared from such dispersions. The pH of the compositions can range from about 7 to about 10. Suitable neutralization agents include but are not limited to alkali hydroxides such as lithium, sodium and potassium, and organic bases such as ammonia and tertiary amines such as triethanolamine, aminomethyl propanol, dimethyl ethanol amine, trimethyl amine, triethylamine morpholine, and mixtures thereof.

### Crosslinkers

Compounds having at least one crosslinkable functional group can also be incorporated into the polyurea/urethane of the present invention, if desired. Examples of such compounds include those having carboxylic, carbonyl, amine, hydroxyl, epoxy, acetoacetoxy, olefinic and hydrazide groups, blocked isocyanates, and the like, and mixtures of such groups and the same groups in protected forms which can be reversed back into original groups from which they were derived. Other suitable compounds providing crosslinkability include thioglycolic acid, 2,6-dihydroxybenzoic acid, melamine and its derivatives, multivalent metal compounds and the like, and mixtures thereof

The amount of optional compounds having crosslinkable functional groups in the prepolymer will typically be up to about 1 milli-equivalent, preferably from about 0.05 to about 0.5 milli-equivalents, and more preferably from about 0.1 to about 0.3 milli-equivalents per gram of final polyurethane on a dry weight basis.

Other additives well known to those skilled in the art can be used to aid in preparation of the dispersions of this invention. Such additives include surfactants, stabilizers, defoamers, thickeners, leveling agents, antimicrobial agents, antioxidants, UV absorbers, fire retardants, pigments, dyes, and the like. These additives can be added at any stage of the manufacturing process.

The dispersions of this invention typically have total solids of at least about 20 weight percent in one aspect, at least about 30 weight percent in another aspect, and at least about 40 weight percent in a further aspect, and about 45 weight percent in still another aspect, based on the weight of the total coating composition.

As coating compositions or adhesives, they may be applied to any substrate including wood, metals, glass, cloth, leather, paper, plastics, foam and the like, by any conventional method including brushing, dipping, flow coating, spraying, and the like.

The compositions of the present invention and their formulations are useful as self-supporting films, coatings on various substrates, or adhesives with longer useful lifetimes than similar polyurethane compositions or other improved properties.

### WORKING EXAMPLES

In these examples, the following reagents were used: Jeffcat™ DPA also known as N-(3-dimethylaminopropyl)-N,N-diisopropanolamine

A typical ink formulation including useful ranges of components, and comprising the inventive polymer binders for digital printing applications is shown in Table 1. Inks comprising the inventive polymeric binders are illustrated below using anionically dispersed pigments. It is possible to use any of the well-known pigments in the art of digital printing applications, including, self-dispersing, polymer encapsulated, surfactant or polymer dispersed to achieve the desired coloration of the digital printing ink. Examples of useful self-dispersing pigments include the Cab-O-Jet® series of carboxylate, sulfonate, or phosphonate functionalized pigments from Cabot Coroporation. Other useful self dispersing pigments include those which have been oxidized via hypohalites, persulfates or ozone to render anionic groups directly onto the surface of the pigment. Pigments may also be dispersed with anionic dispersants which may be monomeric surfactants or polymeric dispersants. Examples of polymeric dispersants can be random, block or graft copolymers of acrylic or styrene acrylic monomers, copolymerized with acidic group containing monomers, such as carboxylic acids or sulfonic acids. It is further contemplated to use dye-based colorants in practice of the current invention in combination with the inventive polymeric binders to make a digital ink.

TABLE 1
Composition of Pigment Inks Used with Inventive Polymer Binders

| | | |
|---|---|---|
| Anionically dispersed Pigment | 3.5-4.5 | wt. % |
| Inventive Polymer Binder | 1-11 | wt. % based on polymer solids |
| Glycol/cyclic amide | 8-15 | wt. % |
| humectants | | |
| Surfactants | 0.1-1.0 | wt. % |
| Optional Cross linker | 0.1-3 | wt. % |
| Biocide | 0-500 | parts per million |

| | |
|---|---|
| Water | Balance to 100% |

### Washing Test

A GE Profile home laundry top loading washer (model #WPRE8100G) was used for the home laundering wash test. The settings were: hot wash and cold rinse, extra-large load and casual heavy wash. The fabric samples were put into the washer together with 5 standard-sized lab coats. A standard washing cycle (45 minutes at 56° C. (132° F.)) was used to wash the fabric for 5 consecutive complete wash cycles. The detergent used was Tide Liquid detergent at the recommended dosage per load. The five home launderings (i.e., the wet garments were rewashed four additional times) were followed by one single tumble dry cycle (on auto cycle permanent press) using an American Motors Corp (Model#DE-840B-53) dryer.

The color values were measured on the colored blocks (CMYRBO) using the CIE 1976 L*,a*,b* color space scale a colorimetric meter made by X-Rite Gretagmacbeth (Model# Color i7). The fabric was then subjected to 5 home launderings and one dry cycle as described above and retested for color values after washing. This is a test of the image color retention after washing.

The polyamides used to form the polymers of the dispersions were formed as follows:

### Polyamide 1

Sebacic acid, dodecanedioic acid, piperazine, and polytetramethylene oxide (PTMO-250) were charged to the reactor under N₂ atmosphere. The reactor was heated to 180° C. and the polymer formed for 6 hours. Dibutyltin dilaurate was added and the reactor pressure was decreased to 1-30 mbar vacuum for 25 hours. The product was a slightly yellowish paste at room temperature with an acid number <3.0 mg KOH/g polymer. The end-groups were hydroxyls.

### Polyamide 2

Dodecanedioic acid, piperazine, and polytetrahydrofuran (avg. molecular wt. 650 g/mol) were charged to the reactor under N₂ atmosphere. The reactor was heated to 180° C. and the polymer formed for 6 hours. Titanium octoate catalyst was added and the reactor pressure was decreased to 1-30 mbar vacuum for 11 hours. The product was a slightly yellowish paste at room temperature with an acid number <3.0 mg KOH/g polymer. The end-groups were hydroxyls.

### Polyamide 3

Sebacic acid, piperazine, and polytetrahydrofuran (avg. molecular wt. 250 g/mol) were charged to the reactor under N₂ atmosphere. The reactor was heated to 180° C. and the polymer formed for 3.5 hr. Succinic acid was added to the reactor and the polymer continued to form at 180° C. for 4.5 hours. Titanium octoate catalyst was added and the reactor pressure was decreased to 1-30 mbar vacuum for 12 hours. The product was a slightly yellowish paste at room temperature with an acid number <3.0 mg KOH/g polymer. The end-groups were hydroxyls.

TABLE 2
Polyamide Compositions

| Component | Polyamide 1 | Polyamide 2 | Polyamide 3 |
|---|---|---|---|
| Sebasic acid | 267.4 g | — | 329.73 g |
| Dodecanoic | 260.9 | 373.13 g | |
| acid | | | |
| Succinic Acid | | | 128.37 |
| Piperazine | 94.1 | 89.31 | 86.78 |
| PTMO | 466.1 (250 MW) | 595.82 (650 MW) | 552.95 (250 MW) |
| Dibutyl tin | 0.1 | — | — |
| Titanium | — | 0.026 | 0.060 |
| octoate | | | |

### PD-A

Dimethylolbutanoic acid and Polyamide 1 were weighed into a reactor, the reactor was heated to 90° C. and stirred until the dimethylolbutanoic acid completely dissolved. Dimethylcarbonate was added during stirring and the reactor was cooled to 60° C. Des W was added during stirring and cooling. Dibutyltin dilaurate was added to the reactor and the reactor was maintained at 90° C. for 2 hours or until the target NCO % was reached. The reactor was then cooled to 70° C. and triethylamine was added. The reactor was further cooled to 55° C., isopropanol was added to the reactor, and the prepared prepolymer was dispersed into RT (room temperature, 20-25° C.) water. The dispersion was chain extended with hydrazine (35% solution in water) over 15 minutes. Solvents and water were evaporated at reduced pressure at 50-55° C. until desired solid content was reached. The final dispersion was an off-white to brown waterborne polyurea/urethane dispersion.

### PD-B

Dimethylolbutanoic acid and Polyamide 1 were weighed into a reactor, the reactor was heated to 90° C. and stirred until the dimethylolbutanoic acid completely dissolved. Dimethylcarbonate was added during stirring and the reactor was cooled to 60° C. Isophorone diisocyanate was added during stirring and cooling. Dibutyltin dilaurate was added to the reactor and the reactor was maintained at 85° C. for 1.5 hours or until the target NCO % was reached. The reactor was then cooled to 70° C. and triethylamine was added. The reactor was further cooled to 55° C., isopropanol was added to the reactor, and the prepared prepolymer was dispersed into RT water. The dispersion was chain extended with hydrazine (35% solution in water) over 15 minutes. Solvents and water were evaporated at reduced pressure at 50-55° C. until desired solid content was reached. The final dispersion was an off-white to brown waterborne polyurea/urethane dispersion.

### PD-C

Dimethylolbutanoic acid and Polyamide 1 were weighed into a reactor, the reactor was heated to 90° C. and stirred until the dimethylolbutanoic acid completely dissolved. Dimethylcarbonate was added during stirring and the reactor was cooled to 60° C. Des W was added during stirring and cooling. Dibutyltin dilaurate was added to the reactor and the reactor was maintained at 90° C. for 2 hours or until the target NCO % was reached. The reactor was then cooled to 70° C. and triethylamine was added. The reactor was further cooled to 55° C., isopropanol was added to the reactor, and the prepared prepolymer was dispersed into RT water. The dispersion was chain extended with hydrazine (35% solution in water) over 15 minutes. Solvents and water were evaporated at reduced pressure at 50-55° C. until desired solid content was reached. The final dispersion was an off-white to brown waterborne polyurea/urethane dispersion.

### PD-D

Dimethylolbutanoic acid and Polyamide 2 were weighed into a reactor, the reactor was heated to 90° C. and stirred until the dimethylolbutanoic acid completely dissolved. Dimethylcarbonate was added during stirring and the reactor was cooled to 60° C. Des W was added during stirring and cooling. Dibutyltin dilaurate was added to the reactor and the reactor was maintained at 85° C. for 2 hours or until the target NCO % was reached. The reactor was then cooled to 70° C. and triethylamine was added. The reactor was further cooled to 55° C. and the prepared prepolymer was dispersed into RT water. The dispersion was chain extended with hydrazine (35% solution in water) over 15 minutes. Solvents and water were evaporated at reduced pressure at 50-55° C. until desired solid content was reached. The final dispersion was a white waterborne polyurea/urethane dispersion.

### PD-E

N,N-dimethylethanolamine, Jeffcat, and Polyamide 3 were weighed into a reactor, the reactor was heated to 80° C. and stirred until all components dissolved. Dimethylcarbonate was added to the reactor during stirring. Des W was added during stirring and the reactor was maintained at 90° C. for 35 minutes or until target NCO % was reached. Diethyl sulfate was added to the reactor during stirring and the reactor was maintained at 90° C. for 3 hours. The reactor was cooled to 50° C. and the prepared prepolymer was dispersed in RT water. The dispersion was chain extended with water at 100-200 mbar at 30-55° C. for 3 hours or until no NCO's are left. Solvents and water were evaporated at reduced pressure at 50-55° C. until desired solid content was reached. The final dispersion was a white waterborne polyurea/urethane dispersion.

TABLE 3
Polyamide Dispersions used to make coatings or inks

| | | | | | PD-E |
|---|---|---|---|---|---|
| Polyamide # | PD-A | PD-B | PD-C | PD-D | (cationic) |
| Polyamide 1 | 111.60 g | 126.00 | 117.00 | — | — |
| Polyamide 2 | — | — | — | 140.00 | — |
| Polyamide 3 | — | — | — | — | 92.91 |
| Dimethylolbutanoic | 8.57 | 8.57 | 7.14 | 10.58 | — |
| acid | | | | | |
| N,N′- | — | — | — | — | 4.07 |
| dimethyl- | | | | | |
| ethanolamine | | | | | |
| Desmodur W | 56.85 | — | 53.12 | 47.15 | 53.81 |
| Isophorone | — | 43.40 | — | — | — |
| diisocyanate | | | | | |
| Jeffcat ™ DPA | — | — | — | — | 10.90 |
| Dimethyl carbonate | 56.0 | 56.0 | 56.0 | 100.0 | 80.0 |
| Isopropanol | 14.0 | 14.0 | 14.0 | — | — |
| Dibutyltin dilaurate | 0.011 | 0.011 | 0.011 | 0.012 | — |
| (catalyst) | | | | | |
| Triethylamine | 6.43 | 6.43 | 5.36 | 7.94 | — |
| Diethyl Sulfate | | | | | 13.27 |
| Water | 738.0 | 739.8 | 739.6 | 687.9 | 748.4 |
| Hydrazine (35 wt % | 8.52 | 5.81 | 7.81 | 6.47 | — |
| active) | | | | | |

Aqueous Pigmented Inks Comprising Inventive Polymers for Digital Printing onto Textile Substrates

An aqueous pigmented ink was prepared by combining propylene glycol; polyethylene glycol 200; ethoxylated acetylenediol surfactant, e.g. Dynol™ 604 from Air Products; fatty amine surfactant, e.g. Schercomid ODA from Lubrizol Corp. having INCI name oleamide DEA (and) diethanolamine; triethanolamine, Promex® Clear biocide and demineralized water and mixing. Next, the inventive polyurethane dispersion PD-A was added followed by the addition of a polymer dispersed carbon black pigment dispersion. The resulting ink, containing 4% pigment and 4% inventive polymer, was mixed for one hour and filtered through a 1 micron Pall disk filter. This ink is herein referred to as black ink 1.

Similar cyan, magenta, and yellow inks were prepared using a polymer dispersed cyan pigment dispersion of PB 15:3, a polymer dispersed magenta pigment dispersion PR122, and a polymer dispersed yellow pigment dispersion of PY 155, respectively. A fluorosurfactant was also used in the case of the cyan, magenta and yellow pigment inks. These inks are herein referred to as cyan ink 1, magenta ink 1, and yellow ink 1, respectively.

Aging stability is a critical feature of digital inks as they need to maintain viscosity and particle size stability during ink storage. The initial physical properties of the inventive ink magental were measured and 20 grams of ink was incubated for 9 days at 70 degrees at which time the ink properties were re-measured. The initial and incubated ink properties are summarized in Table 4 below. The small change in pH, conductivity and viscosity illustrate the excellent accelerated aging stability for the pigmented ink containing the inventive polyurethane dispersion. Ink viscosities were measured using a TA Instruments model HR-2 rheometer, equipped with a cone-plate geometry, at 25° C. and shear rate of 50 l/seconds. Pigment particle diameters were measured on a Malvern Zetasizer model Nano-S90 and reported as Z-average diameter in nanometers.

TABLE 4
Ink Physical Properties of Initial and Incubated magenta ink 1.

| | | | Z-average | |
|---|---|---|---|---|
| | pH at | Viscosity at | diameter | Conductivity |
| | 25° C. | 25° C. | (nm) | (micro-S/cm) |
| Initial Magenta Ink | 8.82 | 3.37 | 139 | 743 |
| Aged 9 days at 70° C. | 8.59 | 3.59 | 155 | 798 |

Black ink 1, cyan ink 1, magenta ink 1 and yellow ink 1 collectively comprise a set of pigmented inks herein referred to as pigment inkset 1.

A similar series of black, cyan, magenta and yellow pigmented inks were formulated as above except inventive polyurethane dispersion PD-B was used in place of PD-A. These inks are herein referred to as black ink 2, cyan ink 2, magenta ink 2, and yellow ink 2. These inks comprise a set of pigmented inks herein referred to as pigment inkset 2.

Digital print inks need to exhibit vibrant colors on white textiles and adhere well to the textile substrate. Pigment inkset 1 and pigment inkset 2 were loaded into a DTG Viper digital printer, manufactured by ColDesi and images were printed onto Anvil 100% white cotton shirts. The cotton shirt was heat pressed after printing for 2 minutes at 160° C. (320° F.) to generate a vibrant image suitable for direct to garment textile printing.

A white ink based on nanodispersed titanium dioxide pigments was formulated with a combination of ethylene glycol and glycerin, acetylene diol and fluorinated surfactants, Promex biocide, cross linker and approximately 11% inventive polymer binder PD-B. The resulting inkjet ink is herein referred to as white ink 1.

To achieve good color vibrancy on black textile substrates it is common practice to print a white layer first and then print with cyan, magenta, and yellow over the white ink. A black cotton Anvil shirt was treated with a pretreatment solution comprising calcium chloride, a mixture of acrylic and vinylacetate binders and a nonionic silicone surfactant using a Wagner power sprayer. The resulting treated textile was then heat pressed for a minute at 320° F. to dry the pretreatment. A black polyester Hanes Cool Dry shirt was treated with a pretreatment solution comprising calcium chloride, aluminum chloride, nonionic acrylic binder and nonionic silicone surfactant using a Wagner power sprayer at approximately 0.1 gms solution/in². The resulting treated textile was then heat pressed for a minute at 250° F. to dry the pretreatment. White ink 1 and Pigment inkset 1 were loaded into a DTG Viper printer, manufactured by ColDesi and both white and colored images were printed onto the black cotton and black polyester shirts. The whiteness of the printed white image was measured using a as measured by an X-Rite Gretagmacbeth colorimetric meter (Model# Color i7) and found to have an L* of 96.3 prior to washing. The printed garments were subjected to the washing test described above and the white patch after washing was found to have an L* of 95.2 after five washing cycles and one drying cycle. This was considered good L* value retention for white ink after washing and drying. The resulting white and colored images showed no visible cracking after the washing cycle indicating good adhesion of the white ink containing the inventive polymer binder. Thus, the inventive white and colored inks showed very good performance on black textile substrates.

Aqueous Pigmented Inks Comprising Inventive PD's Printed onto Photographic Substrates

Effective binders for yellow inks can reduce fading of the yellow pigment under UV light. Fade resistance on photographic images is a key property. A series of yellow pigmented inks were formulated comprising 10% propylene glycol, 8% glycerol, 0.4% Surfynol 465, Promex® Clear biocide, and 4% pigment yellow 74 (from pigment dispersion Pro-Jet Yellow®APD-1000, Fuji Imaging Colorants). Yellow ink 3 was formulated to 4% polymer with polyurethane dispersion PD-A. Yellow ink 4 was formulated to 4% polymer with polyurethane dispersion PD-C. Yellow ink 5 was formulated to 4% polymer with polyurethane dispersion PD-D. The resulting yellow pigmented inks were loaded into aftermarket cartridges and printed onto Epson® Ultra Premium Photo Paper Luster using an Epson C-88 photoprinter. The printed images resulted in vivid yellow photographic images that were comparable to images formed by the commercial ink sold in the C-88 printer. Prints were subjected to high intensity light fade for 2 weeks and showed yellow light fade similar to the Epson control images. Thus, the inventive inks with inventive polyamide polymers showed excellent UV resistance (comparable to commercial Epson controls).

The following examples illustrate the usefulness of the inventive polyamide binders as pretreatments for textile printing the in the field of digital printing. The treatments comprising the inventive polyamide binders can be applied prior to, during or after the application of the colored printing inks. In some cases, the treatment is applied as a pretreatment to application of the colored inks. This pretreatment can be designed to control the deposition of the colored ink in order to achieve high color intensity (vibrancy), to minimize bleed of the different colors into one another or to minimize the penetration of the ink through the textile and onto the backside of the target substrate. In other cases, the treatment comprising the inventive polymer binders is applied after the printed image. Such treatments are sometimes referred to as overcoats, overprint varnish, or clearcoats in the field of digital printing. The properties of the inventive polymeric binders for use in treatments as overcoats can be tailored to improve durability of the printed image or to modify an optical property of the printed image such as, for example, gloss.

### Aqueous Textile Treatments Comprising Inventive PD's for Printing Digital Images

A textile pretreatment composition was prepared comprising 0.3% aluminum chloride hexahydrate, 4.7% calcium chloride dihydrate, 0.5% isopropyl alcohol, 9.7 wt. % inventive cationic polyurethane dispersions PD-E (based on solids) and the balance deionized water. This textile pretreatment, herein referred to as pre-treatment 1, was sprayed onto a black Hanes® Cool Dri polyester T-shirt using a Wagner power spray gun at a laydown of approximately 0.08 gms of solution/in². A series of cyan, magenta, yellow, white and black pigmented inks similar to pigment inkset 1 were loaded into a DTG Viper textile printer and a colored image was printed onto the T-shirt. The resulting printed images were cured in a heat press for 3 minutes at 121° C. (250° F.) to generate a permanent textile image.

A cationic textile pretreatment composition was prepared comprising 9 wt. % cationic polymer using PD-E, 0.2 wt. % dipropyleneglycol, 0.1 wt. % BYK-347 (silicone surfactant) and the balance water. This did not require the aluminium chloride and calcium chloride as the binder was cationic. This pretreatment, herein referred to as pretreatment 2 was applied to a series of textile substrates shown in Table 5 below, at a laydown of approximately 0.08 gms solution/in², and were heat pressed at 250° C. for 1 minute to dry the pretreatment.

A series of cyan, magenta, yellow, white and black pigmented inks similar to pigment inkset 1 (described earlier) were loaded into a DTG Viper textile printer and a series of colored squares of cyan, magenta, yellow, red, green, orange and black were printed onto the textiles. The resulting vivid color images showed little bleeding of the images along the fibers and little penetration of the ink to the backside of the textile. The cationic pretreatment evidently was effective because it limited bleeding and penetration of the ink to the backside.

TABLE 5
Textile Substrates treated with PD-E based pretreatment before
printing

| | | Weight/ | |
|---|---|---|---|
| Material | Description | Thickness | Other |
| Nylon | Spun Nylon 6.6 | 130 gsm | Style #361, |
| | Dupont Type 200 | (grams of | TestFabrics |
| | woven fabric (ISO | solution per | |
| | 105/F03) | square meter) | |
| Silk | Broadcloth | 105 gsm | Style #607, |
| | | | TestFabrics |
| Polyester/Lycra | 93/7 Blend | 143 gsm | Style #700-12, |
| | | | TestFabrics |

Each of the documents referred to above is incorporated herein by reference. Except in the Examples, or where otherwise indicated, all numerical quantities in this description specifying amounts, reaction conditions, molecular weights, number of carbon atoms, etc., are to be understood as modified by the word “about”. Unless otherwise indicated, all molecular weights are number average molecular weights. Unless otherwise indicated, each chemical or composition referred to herein should be interpreted as being a commercial grade material which may contain the isomers, by-products, derivatives, and other such materials which are normally understood to be present in the commercial grade. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of”permits the inclusion of substances that do not materially affect the basic and novel characteristics of the composition under consideration. All of the embodiments of the invention described herein are contemplated from and may be read from both an open-ended and inclusive view (i.e. using “comprising of” language) and a closed and exclusive view (i.e. using “consisting of” language). As used herein parentheses are used designate 1) that the something is optionally present such that monomer(s) means monomer or monomers or (meth)acrylate means methacrylate or acrylate, 2) to qualify or further define a previously mentioned term, or 3) to list narrower embodiments.

While certain representative embodiments and details have been shown for the purpose of illustrating the subject invention, it will be apparent to those skilled in this art that various changes and modifications can be made therein without departing from the scope of the subject invention.

What is claimed is:

1. An ink, substrate pretreatment, ink receptive coating, or overprint varnish comprising a binder dispersed in aqueous media and optional pigment, optional filler, and optional dye; wherein at least 20 wt. % of said binder is characterized as amide repeat units having amide linkages at one or more ends of each repeat unit, said repeat units being derived from amide condensation or ring opening polymerization of monomers selected from dicarboxylic acid, lactam, aminocarboxyic acid, and diamine monomers, and wherein at least 5 wt. % of said binder is repeat units characterized as repeat units derived from polyisocyanates reacted with hydroxyl or amine groups, which results in the isocyanate groups initially at two or more ends of each polyisocyanates being part of a urethane or urea linkage.

2. The ink, substrate pretreatment, ink receptive coating, or overprint varnish according to claim 1, wherein at least 50 mole percent of said amide linkages at the one or more ends of said amide repeat units are characterized as tertiary amide linkages wherein the nitrogen attached to the carbonyl group also has two additional hydrocarbon groups chemically bonded to said nitrogen of said tertiary amide linkage.

3. The ink, substrate pretreatment, ink receptive coating, or overprint varnish according to claim 1, wherein said binder comprises at least 50 wt. % of said amide repeat units having said one or more amide linkages at an end of each repeat unit.

4. The ink, substrate pretreatment, ink receptive coating, or overprint varnish according to claim 1, wherein said binder comprises at least 10 wt. % of said repeat units derived from polyisocyanates, based on the weight of the binder.

5. The ink, substrate pretreatment, ink receptive coating, or overprint varnish according to claim 1, wherein at least 50 mole % of said urethane and/or urea linkages on said repeat units derived from polyisocyanates are urea linkages.

6. The ink, substrate pretreatment, ink receptive coating, or overprint varnish according to claim 1, wherein at least 50 mole % of said urethane and/or urea linkages on said repeat units derived from polyisocyanates are urethane linkages.

7. (canceled)

8. (canceled)

9. The ink, substrate pretreatment, ink receptive coating, or overprint varnish according to claim 1 in the form of an ink, wherein said ink comprises at least one pigment.

10. The ink, substrate pretreatment, ink receptive coating, or overprint varnish according to claim 1 in the form of an ink, wherein said ink comprises from 1 to 22 wt. % of said binder, 3.5 to 4.5 wt. % of a pigment based on the weight of the ink, and water and humectant, further wherein said ink is of appropriate viscosity and colloidal stability to be suitable for ink jet printing.

11. The ink, substrate pretreatment, ink receptive coating, or overprint varnish according to claim 1 in the form of an ink, wherein said ink comprises a reactive dye that comprises a reactive group capable of forming a chemical bond to a substrate.

12. The ink, substrate pretreatment, ink receptive coating, or overprint varnish according to claim 1, wherein said ink, substrate pretreatment, ink receptive coating, or overprint varnish is in the form of a semi-porous substrate pretreatment less the water phase on a substrate.

13. The substrate pretreatment according to claim 12, wherein said pretreatment includes from about 1 to about 12 weight percent of a cationic species incorporated into said binder and based on the weight of said binder.

14. The substrate pretreatment according to claim 12, wherein said pretreatment includes at least about 2 weight percent of nonionic colloidal stabilizing species incorporated into said binder and based on the weight of said binder.

15. The substrate pretreatment according to claim 12, wherein said pretreatment includes from about 0.1 to about 10 weight percent of an azetidinium (AZE) containing polymer based on the weight of said aqueous pretreatment before drying.

16. The substrate pretreatment according to claim 12, wherein said pretreatment is dried into a film between a textile substrate and an image formed with an ink jet applied ink.

17. The ink, substrate pretreatment, according to claim 1, wherein said ink, substrate pretreatment, ink receptive coating, or overprint varnish is an ink receptive coating on a substrate, wherein said substrate has lower ink receptivity than said ink receptive coating.

18. The ink receptive coating according to claim 17, wherein said ink receptive coating further comprises at least 10 wt. % particulate filler based on the weight of the binder in said ink receptive coating.

19. The ink receptive coating according to claim 17, further comprising from about 1 to about 12 weight percent of a cationic species incorporated into said binder and based on the weight of said binder.

20. The ink receptive coating according to claim 17, further comprising at least about 2 weight percent of nonionic colloidal stabilizing species incorporated into said binder and based on the weight of said binder.

21. The ink, substrate pretreatment, ink receptive coating, or overprint varnish according to claim 1, wherein said ink, substrate pretreatment, ink receptive coating, or overprint varnish is a protective overprint coating or varnish over a substrate.

22. (canceled)

23. An ink jet printed image comprising
a substrate,
an ink jet ink applied in the form of an image or text onto said substrate, wherein said ink jet ink is according to claim 1 in the form of an ink comprising at least one pigment or dye,
optionally further including a pretreatment between said substrate and said ink,
optionally further including an ink receptive coating between said substrate and said ink,
optionally further including an overprint varnish on the exterior surface of said image or text formed from said ink jet ink.

24. (canceled)

25. (canceled)
